(19) United States
(12) Patent Application Publication
(10) Pub. No.: US 2025/0231815 A1
(43) Pub. Date: Jul. 17, 2025

(54) WORKLOAD RESOURCE CONTENTION REDUCTION SYSTEM

(71) Applicant: Dell Products L.P., Round Rock, TX (US)

(72) Inventors: Xiangping Chen, Sherborn, MA (US); William Price Dawkins, Lakeway, TX (US); Douglas Lang Farley, Round Rock, TX (US)

(21) Appl. No.: 18/411,110

(22) Filed: Jan. 12, 2024

(51) Int. Cl. G06F 9/50

(52) U.S. Cl. CPC G06F 9/505

(57) ABSTRACT

A workload/resource contention reduction system includes a resource management system coupled to first and second resource devices. The resource management system receives a first workload instruction to perform a first workload, identifies a first workload resource utilization pattern of the first resource device over time by the first workload, and identifies a second workload resource utilization pattern of the first resource device over time by a second workload that is different than the first workload. The resource management system then determines whether an aggregated resource utilization pattern of the first workload resource utilization pattern and the second workload resource utilization pattern exceeds a threshold resource utilization characteristic. If not, the resource management system provides the first workload and the second workload using the first resource device. If so, the resource management system provides the first workload using the second resource device and the second workload using the first resource device.

### BACKGROUND

The present disclosure relates generally to information handling systems, and more particularly to reducing contention by workloads for resource devices included in information handling systems.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, server devices, storage systems, and/or their components, may be used to provide Logically Composed Systems (LCSs) to users that include logical systems that perform workloads using the components in one or more server devices and storage systems. The use of such “disaggregated infrastructure” to provide LCSs enables flexibility in workload placement, the matching of workload intent with Service Level Agreements (SLAs) and resource availability, and/or provides other benefits known in the art. However, the provisioning of workloads using disaggregated infrastructure can raise some issues.

For example, because resources in disaggregated infrastructure may be shared by multiple workloads, “noisy neighbor” workloads may degrade the performance of any particular workload provided using the same resource via contention for that resource at the same time (e.g., when multiple workloads require peak utilization of that resource at the same time). This is particularly true with the “bursty” and cyclical workloads that are often performed using such disaggregated infrastructure, any of which may exhibit relatively large differences in their peak resource utilizations vs. their average resource utilizations, as well as with different types of workloads (e.g., “transactional” vs. “streaming” workloads) that require different types of resource devices (e.g., processing systems vs. networking bandwidth) at different times.

In order to guarantee the SLAs in light of the possibility of the noisy neighbor workloads discussed above, conventional systems often reserve and isolate the resources that are used to perform a corresponding workload, which can lead to resource underutilization, particularly for a workload whose resource utilization fluctuates relatively significantly over time. Furthermore, the resource isolation described above may be difficult to perform, particularly with regard to the use of networking resources and their networking bandwidth by workload(s). Conventional solutions to such issues typically include frequently adjusting available resources (e.g., adding resources, removing resources, etc.) and migrating workloads, which is undesirable.

Accordingly, it would be desirable to provide a workload provisioning system that addresses the issues discussed above.

### SUMMARY

According to one embodiment, an Information Handling System (IHS) includes a processing system; and a memory system that is coupled to the processing system and that includes instructions that, when executed by the processing system, cause the processing system to provide a resource management engine that is configured to: receive a first workload instruction to perform a first workload; identify a first workload resource utilization pattern of a first resource device over time by the first workload; identify a second workload resource utilization pattern of the first resource device over time by a second workload that is different than the first workload; determine whether an aggregated resource utilization pattern of the first workload resource utilization pattern and the second workload resource utilization pattern exceeds a threshold resource utilization characteristic; provide, in response to the aggregated resource utilization pattern not exceeding the threshold resource utilization characteristic, the first workload and the second workload using the first resource device; and provide, in response to the aggregated resource utilization pattern exceeding the threshold resource utilization characteristic, the second workload using the first resource device and the first workload using a second resource device.

### BRIEF DESCRIPTION OF THE DRAWINGS

FIG. 1 is a schematic view illustrating an embodiment of an Information Handling System (IHS).

FIG. 2 is a schematic view illustrating an embodiment of an LCS provisioning system.

FIG. 3 is a schematic view illustrating an embodiment of an LCS provisioning subsystem that may be included in the LCS provisioning system of FIG. 2.

FIG. 4 is a schematic view illustrating an embodiment of a resource system that may be included in the LCS provisioning subsystem of FIG. 3.

FIG. 5 is a schematic view illustrating an embodiment of the provisioning of an LCS using the LCS provisioning system of FIG. 2.

FIG. 6 is a schematic view illustrating an embodiment of the provisioning of an LCS using the LCS provisioning system of FIG. 2.

FIG. 7 is a schematic view illustrating an embodiment of an LCS provisioning system that may provide the LCS provisioning system of FIG. 2.

FIG. 8 is a schematic view illustrating an embodiment of a resource management system that may be included in the LCS provisioning system of FIG. 7.

FIG. 9 is a flow chart illustrating an embodiment of a method for reducing resource contention from workloads.

FIG. 10A is a schematic view illustrating an embodiment of the operation of the LCS provisioning system of FIG. 7 during the method of FIG. 9.

FIG. 10B is a schematic view illustrating an embodiment of the operation of the resource management system of FIG. 8 during the method of FIG. 9.

FIG. 10C is a schematic view illustrating an embodiment of the operation of the resource management system of FIG. 8 during the method of FIG. 9.

FIG. 11 is a schematic view illustrating an embodiment of the operation of the resource management system of FIG. 8 during the method of FIG. 9.

FIG. 12 is a schematic view illustrating an embodiment of the operation of the resource management system of FIG. 8 during the method of FIG. 9.

FIG. 13 is a chart view illustrating an embodiment of a first workload resource utilization pattern for a resource device by a first workload that may be performed during the method of FIG. 9.

FIG. 14 is a chart view illustrating an embodiment of a second workload resource utilization pattern for a resource device by a second workload that may be performed during the method of FIG. 9.

FIG. 15 is a chart view illustrating an embodiment of a second workload resource utilization pattern for a resource device by a second workload that may be performed during the method of FIG. 9.

FIG. 16 is a chart view illustrating an embodiment of an aggregated workload resource utilization pattern for a resource device by the first and second workloads of FIGS. 13 and 14 that may be utilized during the method of FIG. 9.

FIG. 17 is a chart view illustrating an embodiment of an aggregated workload resource utilization pattern for a resource device by the first and second workloads of FIGS. 13 and 15 that may be utilized during the method of FIG. 9.

FIG. 18A is a schematic view illustrating an embodiment of the operation of the resource management system of FIG. 8 during the method of FIG. 9.

FIG. 18B is a schematic view illustrating an embodiment of the operation of the LCS provisioning system of FIG. 7 during the method of FIG. 9.

FIG. 19A is a schematic view illustrating an embodiment of the operation of the resource management system of FIG. 8 during the method of FIG. 9.

FIG. 19B is a schematic view illustrating an embodiment of the operation of the LCS provisioning system of FIG. 7 during the method of FIG. 9.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

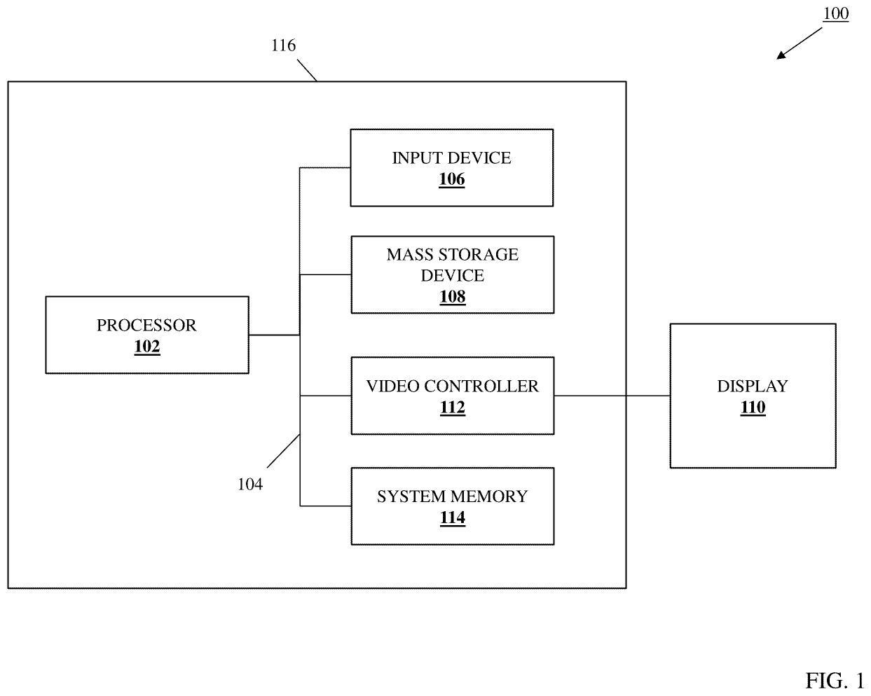

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

As discussed in further detail below, the workload resource contention reduction systems and methods of the present disclosure may be utilized with Logically Composed Systems (LCSs), which one of skill in the art in possession of the present disclosure will recognize may be provided to users as part of an intent-based, as-a-Service delivery platform that enables multi-cloud computing while keeping the corresponding infrastructure that is utilized to do so “invisible” to the user in order to, for example, simplify the user/workload performance experience. As such, the LCSs discussed herein enable relatively rapid utilization of technology from a relatively broader resource pool, optimize the allocation of resources to workloads to provide improved scalability and efficiency, enable seamless introduction of new technologies and value-add services, and/or provide a variety of other benefits that would be apparent to one of skill in the art in possession of the present disclosure.

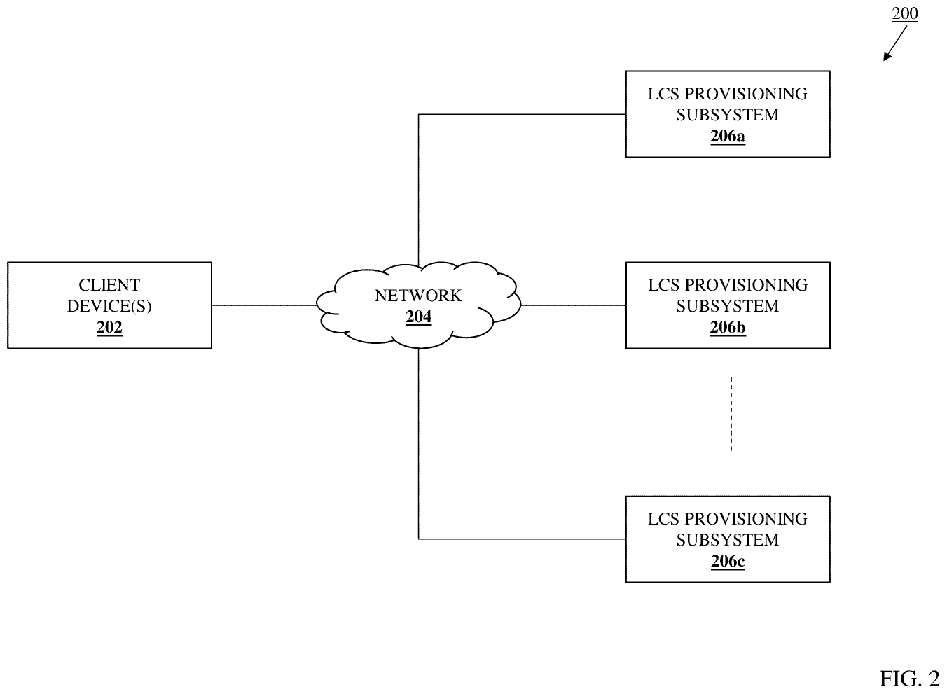

With reference to FIG. 2, an embodiment of a Logically Composed System (LCS) provisioning system 200 is illustrated that may be utilized with the workload resource contention reduction systems and methods of the present disclosure. In the illustrated embodiment, the LCS provisioning system 200 includes one or more client devices 202. In an embodiment, any or all of the client devices 202 may be provided by the IHS 100 discussed above with reference to FIG. 1 and/or may include some or all of the components of the IHS 100, and in specific examples may be provided by desktop computing devices, laptop/notebook computing devices, tablet computing devices, mobile phones, and/or any other computing device known in the art. However, while illustrated and discussed as being provided by specific computing devices, one of skill in the art in possession of the present disclosure will recognize that the functionality of the client device(s) 202 discussed below may be provided by other computing devices that are configured to operate similarly as the client device(s) 202 discussed below, and that one of skill in the art in possession of the present disclosure would recognize as utilizing the LCSs described herein. As illustrated, the client device(s) 202 may be coupled to a network 204 that may be provided by a Local Area Network (LAN), the Internet, combinations thereof, and/or any other network that would be apparent to one of skill in the art in possession of the present disclosure.

As also illustrated in FIG. 2, a plurality of LCS provisioning subsystems 206a, 206b, and up to 206c are coupled to the network 204 such that any or all of those LCS provisioning subsystems 206a-206c may provide LCSs to the client device(s) 202 as discussed in further detail below. In an embodiment, any or all of the LCS provisioning subsystems 206a-206c may include one or more of the IHS 100 discussed above with reference to FIG. 1 and/or may include some or all of the components of the IHS 100. In some of the specific examples provided below, each of the LCS provisioning subsystems 206a-206c may be provided by a respective datacenter or other computing device/computing component location (e.g., a respective one of the “clouds” that enables the “multi-cloud” computing discussed above) in which the components of that LCS provisioning subsystem are included. However, while a specific configuration of the LCS provisioning system 200 (e.g., including multiple LCS provisioning subsystems 206a-206c) is illustrated and described, one of skill in the art in possession of the present disclosure will recognize that other configurations of the LCS provisioning system 200 (e.g., a single LCS provisioning subsystem, LCS provisioning subsystems that span multiple datacenters/computing device/computing component locations, etc.) will fall within the scope of the present disclosure as well.

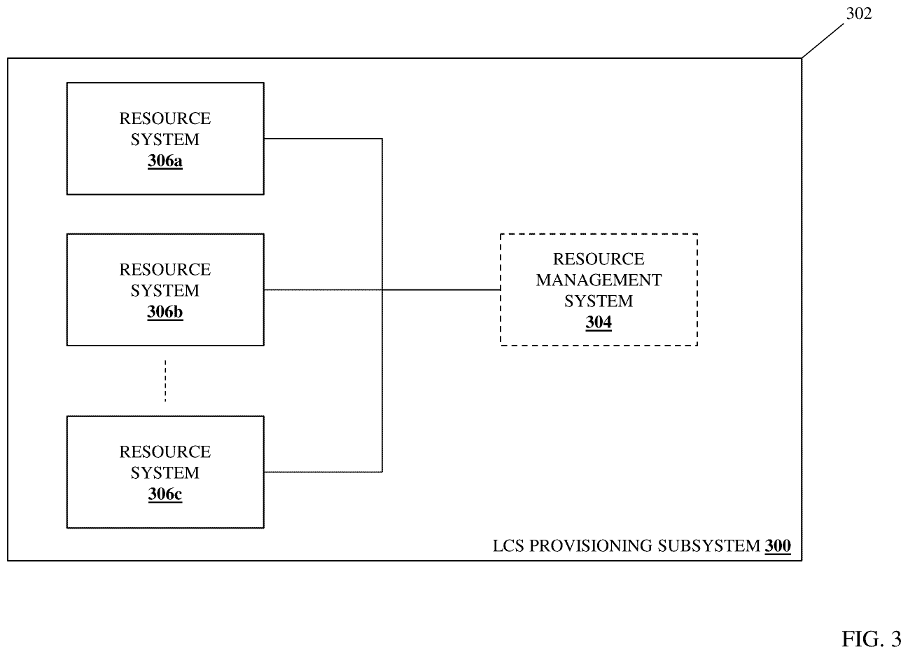

With reference to FIG. 3, an embodiment of an LCS provisioning subsystem 300 is illustrated that may provide any of the LCS provisioning subsystems 206a-206c discussed above with reference to FIG. 2. As such, the LCS provisioning subsystem 300 may include one or more of the IHS 100 discussed above with reference to FIG. 1 and/or may include some or all of the components of the IHS 100, and in the specific examples provided below may be provided by a datacenter or other computing device/computing component location in which the components of the LCS provisioning subsystem 300 are included. However, while a specific configuration of the LCS provisioning subsystem 300 is illustrated and described, one of skill in the art in possession of the present disclosure will recognize that other configurations of the LCS provisioning subsystem 300 will fall within the scope of the present disclosure as well.

In the illustrated embodiment, the LCS provisioning subsystem 300 is provided in a datacenter 302, and includes a resource management system 304 coupled to a plurality of resource systems 306a, 306b, and up to 306c. In an embodiment, any of the resource management system 304 and the resource systems 306a-306c may be provided by the IHS 100 discussed above with reference to FIG. 1 and/or may include some or all of the components of the IHS 100. In the specific embodiments provided below, each of the resource management system 304 and the resource systems 306a-306c may include a System Control Processor (SCP) device that may be conceptualized as an “enhanced” SmartNIC device that may be configured to perform functionality that is not available in conventional SmartNIC devices such as, for example, the resource management functionality, LCS provisioning functionality, and/or other SCP functionality described herein.

In an embodiment, any of the resource systems 306a-306c may include any of the resources described below coupled to an SCP device that is configured to facilitate management of those resources by the resource management system 304. Furthermore, the SCP device included in the resource management system 304 may provide an SCP Manager (SCPM) subsystem that is configured to manage the SCP devices in the resource systems 306a-306c, and that performs the functionality of the resource management system 304 described below. In some examples, the resource management system 304 may be provided by a “stand-alone” system (e.g., that is provided in a separate chassis from each of the resource systems 306a-306c), and the SCPM subsystem discussed below may be provided by a dedicated SCP device, processing/memory resources, and/or other components in that resource management system 304. However, in other embodiments, the resource management system 304 may be provided by one of the resource systems 306a-306c (e.g., it may be provided in a chassis of one of the resource systems 306a-306c), and the SCPM subsystem may be provided by an SCP device, processing/memory resources, and/or any other any other components in that resource system.

As such, the resource management system 304 is illustrated with dashed lines in FIG. 3 to indicate that it may be a stand-alone system in some embodiments, or may be provided by one of the resource systems 306a-306c in other embodiments. Furthermore, one of skill in the art in possession of the present disclosure will appreciate how SCP devices in the resource systems 306a-306c may operate to “elect” or otherwise select one or more of those SCP devices to operate as the SCPM subsystem that provides the resource management system 304 described below. However, while a specific configuration of the LCS provisioning subsystem 300 is illustrated and described, one of skill in the art in possession of the present disclosure will recognize that other configurations of the LCS provisioning subsystem 300 will fall within the scope of the present disclosure as well.

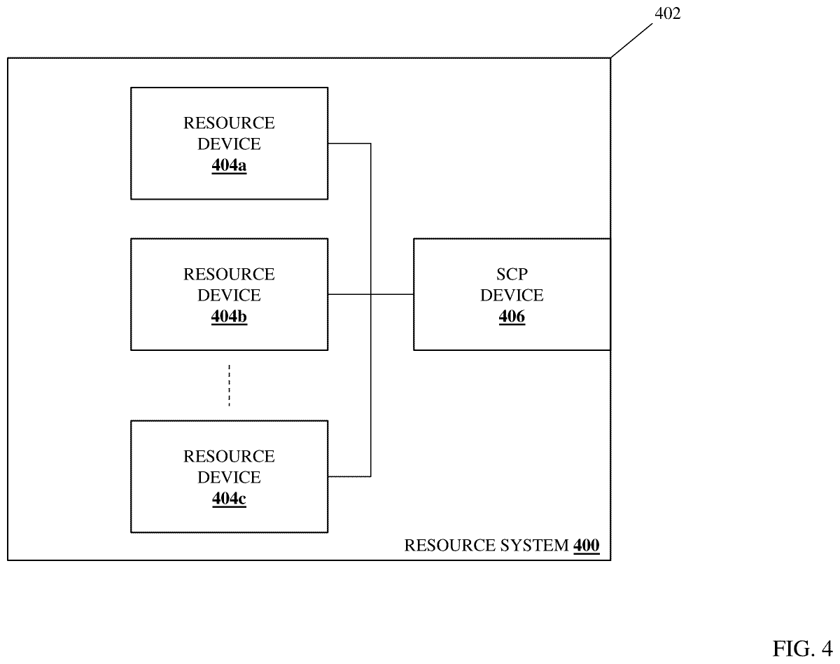

With reference to FIG. 4, an embodiment of a resource system 400 is illustrated that may provide any or all of the resource systems 306a-306c discussed above with reference to FIG. 3. In an embodiment, the resource system 400 may be provided by the IHS 100 discussed above with reference to FIG. 1 and/or may include some or all of the components of the IHS 100. In the illustrated embodiment, the resource system 400 includes a chassis 402 that houses the components of the resource system 400, only some of which are illustrated and discussed below. In the illustrated embodiment, the chassis 402 houses an SCP device 406. In an embodiment, the SCP device 406 may include a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide an SCP engine that is configured to perform the functionality of the SCP engines and/or SCP devices discussed below. Furthermore, the SCP device 406 may also include any of a variety of SCP components (e.g., hardware/software) that are configured to enable any of the SCP functionality described below.

In the illustrated embodiment, the chassis 402 also houses a plurality of resource devices 404a, 404b, and up to 404c, each of which is coupled to the SCP device 406. For example, the resource devices 404a-404c may include processing systems (e.g., first type processing systems such as those available from INTEL® Corporation of Santa Clara, California, United States, second type processing systems such as those available from ADVANCED MICRO DEVICES (AMD)® Inc. of Santa Clara, California, United States, Advanced Reduced Instruction Set Computer (RISC) Machine (ARM) devices, Graphics Processing Unit (GPU) devices, Tensor Processing Unit (TPU) devices, Field Programmable Gate Array (FPGA) devices, accelerator devices, etc.); memory systems (e.g., Persistence MEMory (PMEM) devices (e.g., solid state byte-addressable memory devices that reside on a memory bus), etc.); storage devices (e.g., Non-Volatile Memory express over Fabric (NVMe-oF) storage devices, Just a Bunch Of Flash (JBOF) devices, etc.); networking devices (e.g., Network Interface Controller (NIC) devices, etc.); and/or any other devices that one of skill in the art in possession of the present disclosure would recognize as enabling the functionality described as being enabled by the resource devices 404a-404c discussed below. As such, the resource devices 404a-404c in the resource systems 306a-306c/400 may be considered a “pool” of resources that are available to the resource management system 304 for use in composing LCSs.

To provide a specific example, the SCP devices described herein may operate to provide a Root-of-Trust (RoT) for their corresponding resource devices/systems, to provide an intent management engine for managing the workload intents discussed below, to perform telemetry generation and/or reporting operations for their corresponding resource devices/systems, to perform identity operations for their corresponding resource devices/systems, provide an image boot engine (e.g., an operating system image boot engine) for LCSs composed using a processing system/memory system controlled by that SCP device, and/or perform any other operations that one of skill in the art in possession of the present disclosure would recognize as providing the functionality described below. Further, as discussed below, the SCP devices describe herein may include Software-Defined Storage (SDS) subsystems, inference subsystems, data protection subsystems, Software-Defined Networking (SDN) subsystems, trust subsystems, data management subsystems, compression subsystems, encryption subsystems, and/or any other hardware/software described herein that may be allocated to an LCS that is composed using the resource devices/systems controlled by that SCP device. However, while an SCP device is illustrated and described as performing the functionality discussed below, one of skill in the art in possession of the present disclosure will appreciate how functionality described herein may be enabled on other devices while remaining within the scope of the present disclosure as well.

Thus, the resource system 400 may include the chassis 402 including the SCP device 406 connected to any combinations of resource devices. To provide a specific embodiment, the resource system 400 may provide a “Bare Metal Server” that one of skill in the art in possession of the present disclosure will recognize may be a physical server system that provides dedicated server hosting to a single tenant, and thus may include the chassis 402 housing a processing system and a memory system, the SCP device 406, as well as any other resource devices that would be apparent to one of skill in the art in possession of the present disclosure. However, in other specific embodiments, the resource system 400 may include the chassis 402 housing the SCP device 406 coupled to particular resource devices 404a-404c. For example, the chassis 402 of the resource system 400 may house a plurality of processing systems (i.e., the resource devices 404a-404c) coupled to the SCP device 406. In another example, the chassis 402 of the resource system 400 may house a plurality of memory systems (i.e., the resource devices 404a-404c) coupled to the SCP device 406. In another example, the chassis 402 of the resource system 400 may house a plurality of storage devices (i.e., the resource devices 404a-404c) coupled to the SCP device 406. In another example, the chassis 402 of the resource system 400 may house a plurality of networking devices (i.e., the resource devices 404a-404c) coupled to the SCP device 406. However, one of skill in the art in possession of the present disclosure will appreciate that the chassis 402 of the resource system 400 housing a combination of any of the resource devices discussed above will fall within the scope of the present disclosure as well.

As discussed in further detail below, the SCP device 406 in the resource system 400 will operate with the resource management system 304 (e.g., an SCPM subsystem) to allocate any of its resources devices 404a-404c for use in a providing an LCS. Furthermore, the SCP device 406 in the resource system 400 may also operate to allocate SCP hardware and/or perform functionality, which may not be available in a resource device that it has allocated for use in providing an LCS, in order to provide any of a variety of functionality for the LCS. For example, the SCP engine and/or other hardware/software in the SCP device 406 may be configured to perform encryption functionality, compression functionality, and/or other storage functionality known in the art, and thus if that SCP device 406 allocates storage device(s) (which may be included in the resource devices it controls) for use in a providing an LCS, that SCP device 406 may also utilize its own SCP hardware and/or software to perform that encryption functionality, compression functionality, and/or other storage functionality as needed for the LCS as well. However, while particular SCP-enabled storage functionality is described herein, one of skill in the art in possession of the present disclosure will appreciate how the SCP devices 406 described herein may allocate SCP hardware and/or perform other enhanced functionality for an LCS provided via allocation of its resource devices 404a-404c while remaining within the scope of the present disclosure as well.

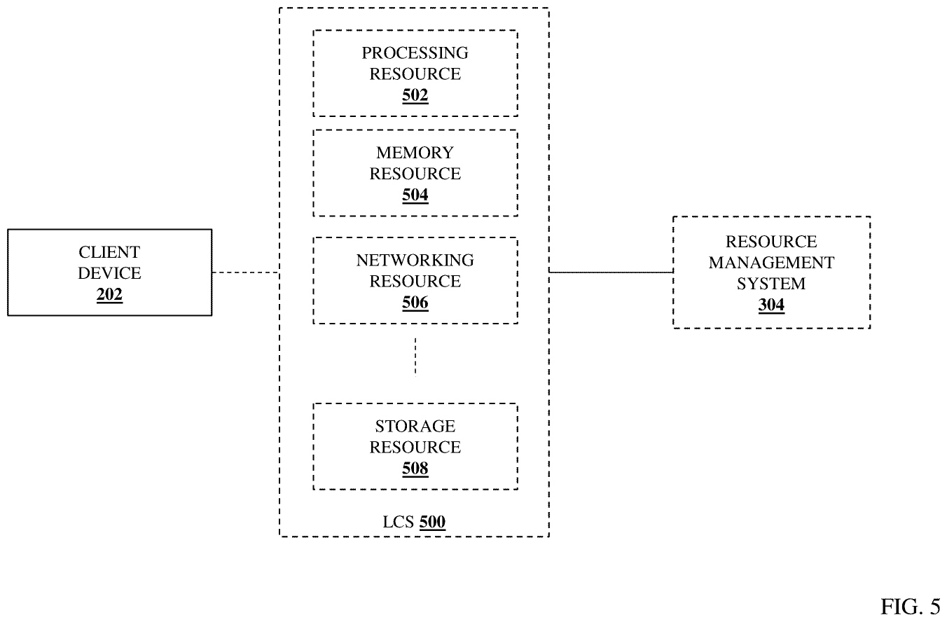

With reference to FIG. 5, an example of the provisioning of an LCS 500 to one of the client device(s) 202 is illustrated. For example, the LCS provisioning system 200 may allow a user of the client device 202 to express a “workload intent” that describes the general requirements of a workload that user would like to perform (e.g., “I need an LCS with 10 gigahertz (Ghz) of processing power and 8 gigabytes (GB) of memory capacity for an application requiring 20 terabytes (TB) of high-performance protected-object-storage for use with a hospital-compliant network”, or “I need an LCS for a machine-learning environment requiring Tensorflow processing with 3 TBs of Accelerator PMEM memory capacity”). As will be appreciated by one of skill in the art in possession of the present disclosure, the workload intent discussed above may be provided to one of the LCS provisioning subsystems 206a-206c, and may be satisfied using resource systems that are included within that LCS provisioning subsystem, or satisfied using resource systems that are included across the different LCS provisioning subsystems 206a-206c.

As such, the resource management system 304 in the LCS provisioning subsystem that received the workload intent may operate to compose the LCS 500 using resource devices 404a-404c in the resource systems 306a-306c/400 in that LCS provisioning subsystem, and/or resource devices 404a-404c in the resource systems 306a-306c/400 in any of the other LCS provisioning subsystems. FIG. 5 illustrates the LCS 500 including a processing resource 502 allocated from one or more processing systems provided by one or more of the resource devices 404a-404c in one or more of the resource systems 306a-306c/400 in one or more of the LCS provisioning subsystems 206a-206c, a memory resource 504 allocated from one or more memory systems provided by one or more of the resource devices 404a-404c in one or more of the resource systems 306a-306c/400 in one or more of the LCS provisioning subsystems 206a-206c, a networking resource 506 allocated from one or more networking devices provided by one or more of the resource devices 404a-404c in one or more of the resource systems 306a-306c/400 in one or more of the LCS provisioning subsystems 206a-206c, and/or a storage resource 508 allocated from one or more storage devices provided by one or more of the resource devices 404a-404c in one or more of the resource systems 306a-306c/400 in one or more of the LCS provisioning subsystems 206a-206c.

Furthermore, as will be appreciated by one of skill in the art in possession of the present disclosure, any of the processing resource 502, memory resource 504, networking resource 506, and the storage resource 508 may be provided from a portion of a processing system (e.g., a core in a processor, a time-slice of processing cycles of a processor, etc.), a portion of a memory system (e.g., a subset of memory capacity in a memory device), a portion of a storage device (e.g., a subset of storage capacity in a storage device), and/or a portion of a networking device (e.g., a portion of the bandwidth of a networking device). Further still, as discussed above, the SCP device(s) 406 in the resource systems 306a-306c/400 that allocate any of the resource devices 404a-404c that provide the processing resource 502, memory resource 504, networking resource 506, and the storage resource 508 in the LCS 500 may also allocate their SCP hardware and/or perform enhanced functionality (e.g., the enhanced storage functionality in the specific examples provided above) for any of those resources that may otherwise not be available in the processing system, memory system, storage device, or networking device allocated to provide those resources in the LCS 500.

With the LCS 500 composed using the processing resources 502, the memory resources 504, the networking resources 506, and the storage resources 508, the resource management system 304 may provide the client device 202 resource communication information such as, for example, Internet Protocol (IP) addresses of each of the systems/devices that provide the resources that make up the LCS 500, in order to allow the client device 202 to communicate with those systems/devices in order to utilize the resources that make up the LCS 500. As will be appreciated by one of skill in the art in possession of the present disclosure, the resource communication information may include any information that allows the client device 202 to present the LCS 500 to a user in a manner that makes the LCS 500 appear the same as an integrated physical system having the same resources as the LCS 500.

Thus, continuing with the specific example above in which the user provided the workload intent defining an LCS with a 10 Ghz of processing power and 8 GB of memory capacity for an application with 20 TB of high-performance protected object storage for use with a hospital-compliant network, the processing resources 502 in the LCS 500 may be configured to utilize 10 Ghz of processing power from processing systems provided by resource device(s) in the resource system(s), the memory resources 504 in the LCS 500 may be configured to utilize 8 GB of memory capacity from memory systems provided by resource device(s) in the resource system(s), the storage resources 508 in the LCS 500 may be configured to utilize 20 TB of storage capacity from high-performance protected-object-storage storage device(s) provided by resource device(s) in the resource system(s), and the networking resources 506 in the LCS 500 may be configured to utilize hospital-compliant networking device(s) provided by resource device(s) in the resource system(s).

Similarly, continuing with the specific example above in which the user provided the workload intent defining an LCS for a machine-learning environment for Tensorflow processing with 3 TBs of Accelerator PMEM memory capacity, the processing resources 502 in the LCS 500 may be configured to utilize TPU processing systems provided by resource device(s) in the resource system(s), and the memory resources 504 in the LCS 500 may be configured to utilize 3 TB of accelerator PMEM memory capacity from processing systems/memory systems provided by resource device(s) in the resource system(s), while any networking/storage functionality may be provided for the networking resources 506 and storage resources 508, if needed.

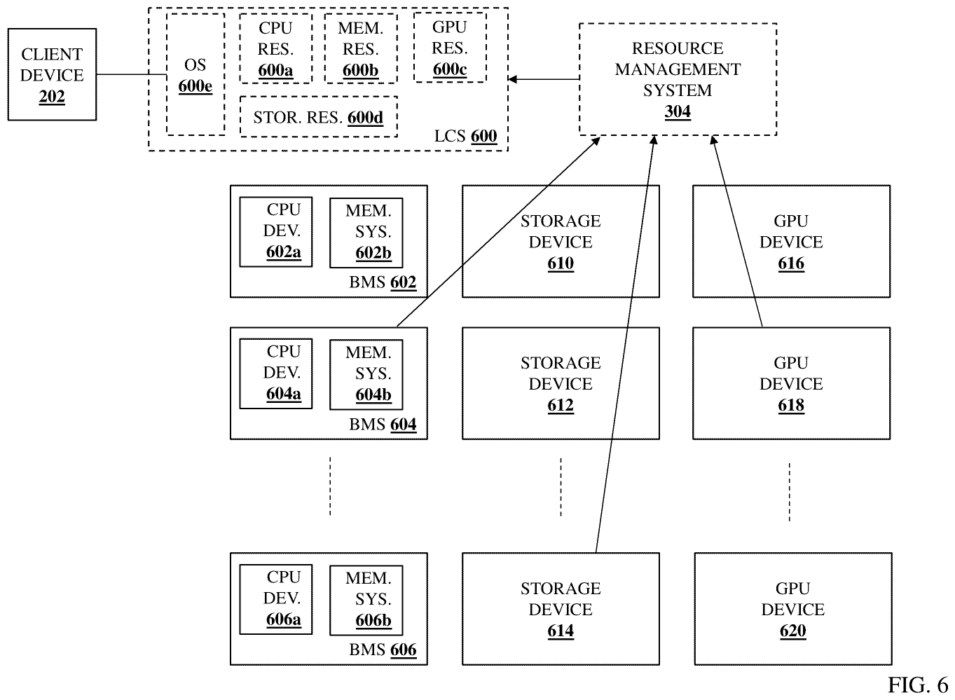

With reference to FIG. 6, another example of the provisioning of an LCS 600 to one of the client device(s) 202 is illustrated. As will be appreciated by one of skill in the art in possession of the present disclosure, many of the LCSs provided by the LCS provisioning system 200 will utilize a “compute” resource (e.g., provided by a processing resource such as an x86 processor, an AMD processor, an ARM processor, and/or other processing systems known in the art, along with a memory system that includes instructions that, when executed by the processing system, cause the processing system to perform any of a variety of compute operations known in the art), and in many situations those compute resources may be allocated from a Bare Metal Server (BMS) and presented to a client device 202 user along with storage resources, networking resources, other processing resources (e.g., GPU resources), and/or any other resources that would be apparent to one of skill in the art in possession of the present disclosure.

As such, in the illustrated embodiment, the resource systems 306a-306c available to the resource management system 304 include a Bare Metal Server (BMS) 602 having a Central Processing Unit (CPU) device 602a and a memory system 602b, a BMS 604 having a CPU device 604a and a memory system 604b, and up to a BMS 606 having a CPU device 606a and a memory system 606b. Furthermore, one or more of the resource systems 306a-306c includes resource devices 404a-404c provided by a storage device 610, a storage device 612, and up to a storage device 614. Further still, one or more of the resource systems 306a-306c includes resource devices 404a-404c provided by a Graphics Processing Unit (GPU) device 616, a GPU device 618, and up to a GPU device 620.

FIG. 6 illustrates how the resource management system 304 may compose the LCS 600 using the BMS 604 to provide the LCS 600 with CPU resources 600a that utilize the CPU device 604a in the BMS 604, and memory resources 600b that utilize the memory system 604b in the BMS 604. Furthermore, the resource management system 304 may compose the LCS 600 using the storage device 614 to provide the LCS 600 with storage resources 600d, and using the GPU device 318 to provide the LCS 600 with GPU resources 600c. As illustrated in the specific example in FIG. 6, the CPU device 604a and the memory system 604b in the BMS 604 may be configured to provide an operating system 600e that is presented to the client device 202 as being provided by the CPU resources 600a and the memory resources 600b in the LCS 600, with operating system 600e utilizing the GPU device 618 to provide the GPU resources 600c in the LCS 600, and utilizing the storage device 614 to provide the storage resources 600d in the LCS 600. The user of the client device 202 may then provide any application(s) on the operating system 600e provided by the CPU resources 600a/CPU device 604a and the memory resources 600b/memory system 604b in the LCS 600/BMS 604, with the application(s) operating using the CPU resources 600a/CPU device 604a, the memory resources 600b/memory system 604b, the GPU resources 600c/GPU device 618, and the storage resources 600d/storage device 614.

Furthermore, as discussed above, the SCP device(s) 406 in the resource systems 306a-306c/400 that allocates any of the CPU device 604a and memory system 604b in the BMS 604 that provide the CPU resource 600a and memory resource 600b, the GPU device 618 that provides the GPU resource 600c, and the storage device 614 that provides storage resource 600d, may also allocate SCP hardware and/or perform enhanced functionality (e.g., the enhanced storage functionality in the specific examples provided above) for any of those resources that may otherwise not be available in the CPU device 604a, memory system 604b, storage device 614, or GPU device 618 allocated to provide those resources in the LCS 500.

However, while simplified examples are described above, one of skill in the art in possession of the present disclosure will appreciate how multiple devices/systems (e.g., multiple CPUs, memory systems, storage devices, and/or GPU devices) may be utilized to provide an LCS. Furthermore, any of the resources utilized to provide an LCS (e.g., the CPU resources, memory resources, storage resources, and/or GPU resources discussed above) need not be restricted to the same device/system, and instead may be provided by different devices/systems over time (e.g., the GPU resources 600c may be provided by the GPU device 618 during a first time period, by the GPU device 616 during a second time period, and so on) while remaining within the scope of the present disclosure as well. Further still, while the discussions above imply the allocation of physical hardware to provide LCSs, one of skill in the art in possession of the present disclosure will recognize that the LCSs described herein may be composed similarly as discussed herein from virtual resources. For example, the resource management system 304 may be configured to allocate a portion of a logical volume provided in a Redundant Array of Independent Disk (RAID) system to an LCS, allocate a portion/time-slice of GPU processing performed by a GPU device to an LCS, and/or perform any other virtual resource allocation that would be apparent to one of skill in the art in possession of the present disclosure in order to compose an LCS.

Similarly as discussed above, with the LCS 600 composed using the CPU resources 600a, the memory resources 600b, the GPU resources 600c, and the storage resources 600d, the resource management system 304 may provide the client device 202 resource communication information such as, for example, Internet Protocol (IP) addresses of each of the systems/devices that provide the resources that make up the LCS 600, in order to allow the client device 202 to communicate with those systems/devices in order to utilize the resources that make up the LCS 600. As will be appreciated by one of skill in the art in possession of the present disclosure, the resource communication information allows the client device 202 to present the LCS 600 to a user in a manner that makes the LCS 600 appear the same as an integrated physical system having the same resources as the LCS 600.

As will be appreciated by one of skill in the art in possession of the present disclosure, the LCS provisioning system 200 discussed above solves issues present in conventional Information Technology (IT) infrastructure systems that utilize “purpose-built” devices (server devices, storage devices, etc.) in the performance of workloads and that often result in resources in those devices being underutilized. This is accomplished, at least in part, by having the resource management system(s) 304 “build” LCSs that satisfy the needs of workloads when they are deployed. As such, a user of a workload need simply define the needs of that workload via a “manifest” expressing the workload intent of the workload, and resource management system 304 may then compose an LCS by allocating resources that define that LCS and that satisfy the requirements expressed in its workload intent, and present that LCS to the user such that the user interacts with those resources in same manner as they would physical system at their location having those same resources.

However, as discussed above, when resource devices in disaggregated infrastructure are shared by multiple workloads performed by one or more LCSs, “noisy neighbor” workloads may degrade the performance of any particular workload provided using the same resource device via contention for that resource device at the same time (e.g., when multiple workloads require peak utilization of that resource device at the same time), and in order to guarantee the SLAs in light of the possibility of the noisy neighbor workloads discussed above, conventional systems often reserve and isolate the resources that are used to perform a corresponding workload. However, such solutions lead to resource underutilization and may be difficult to perform, particularly with regard to the use of networking resources and their networking bandwidth by workload(s). As such, conventional workload provisioning systems often operate to frequently adjust available resources (e.g., adding resources, removing resources, etc.) and migrate workloads, which is undesirable.

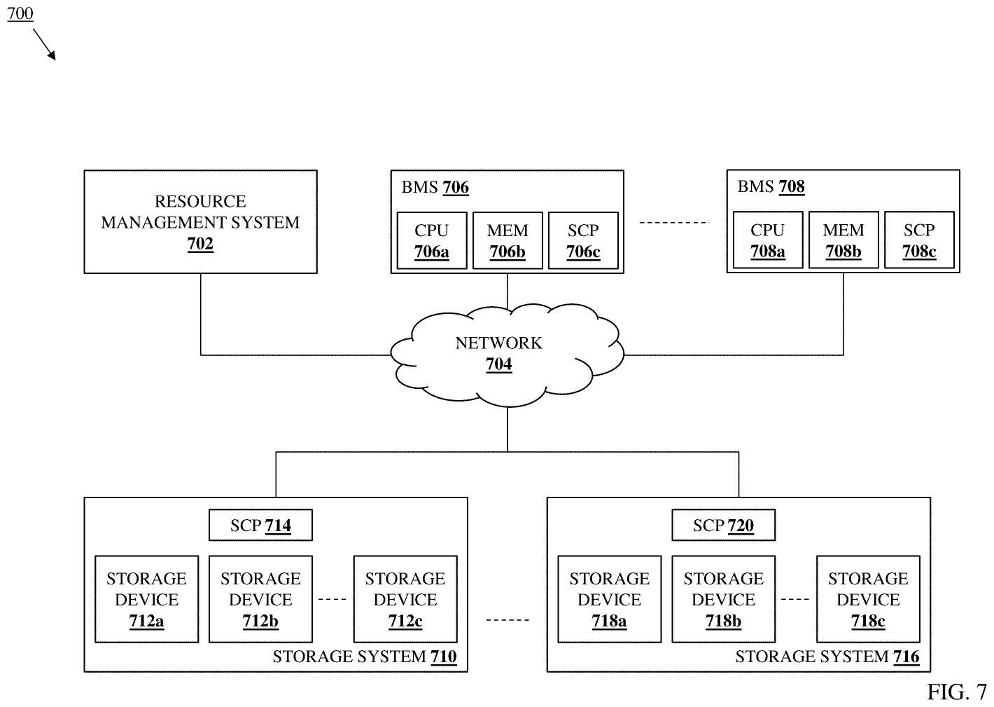

Referring now to FIG. 7, an embodiment of an LCS provisioning system 700 is illustrated that may be provided by the LCS provisioning system 200 discussed above with reference to FIG. 2, and that may utilize the workload resource contention reduction system of the present disclosure to address the issues with conventional workload provisioning systems described above. In the illustrated embodiment, the LCS provisioning system 700 includes a resource management system 702 that may be provided by the resource management system 304 discussed above with reference to FIG. 3 and thus may be provided by an SCPM in some embodiments. However, while illustrated and discussed as being provided by an SCPM, one of skill in the art in possession of the present disclosure will recognize that resource management systems provided in the LCS provisioning system 700 may include any devices that may be configured to operate similarly as the resources management system 702 discussed below. As illustrated, the resource management system 702 may be coupled to a network 704 that may be provided by a Local Area Network (LAN), the Internet, combinations thereof, and/or any other network that would be apparent to one of skill in the art in possession of the present disclosure.

Similarly as described above, a plurality of resource systems and/or resource devices may be coupled to the resource management system 702 via the network 704. For example, the LCS provisioning system 700 illustrated in FIG. 7 includes a BMS 706 having a processing system (e.g., the “CPU” 706a), a memory system (e.g., the “MEM” 706b), and an SCP device (e.g., the “SCP” 706c); and up to a BMS 708 having a processing system (e.g., the “CPU” 708a), a memory system (e.g., the “MEM” 708b), and an SCP device (e.g., the “SCP” 708c). Furthermore, the LCS provisioning system 700 illustrated in FIG. 7 also includes a storage system 710 having a plurality of storage devices 712a, 712b, and up to 712c, as well as an SCP device (e.g., the “SCP” 714); and up to a storage system 716 having a plurality of storage devices 718a, 718b, and up to 718c, as well as an SCP device (e.g., the “SCP” 720). However, while particular resource systems and resource devices are illustrated and described for discussion of the specific examples provided below, one of skill in the art in possession of the present disclosure will appreciate how any of a variety of resource systems and/or resource devices will fall within the scope of the present disclosure as well. Furthermore, while a specific LCS provisioning system 700 has been illustrated and described, one of skill in the art in possession of the present disclosure will recognize that the workload resource contention reduction system of the present disclosure may include a variety of components and component configurations while remaining within the scope of the present disclosure as well.

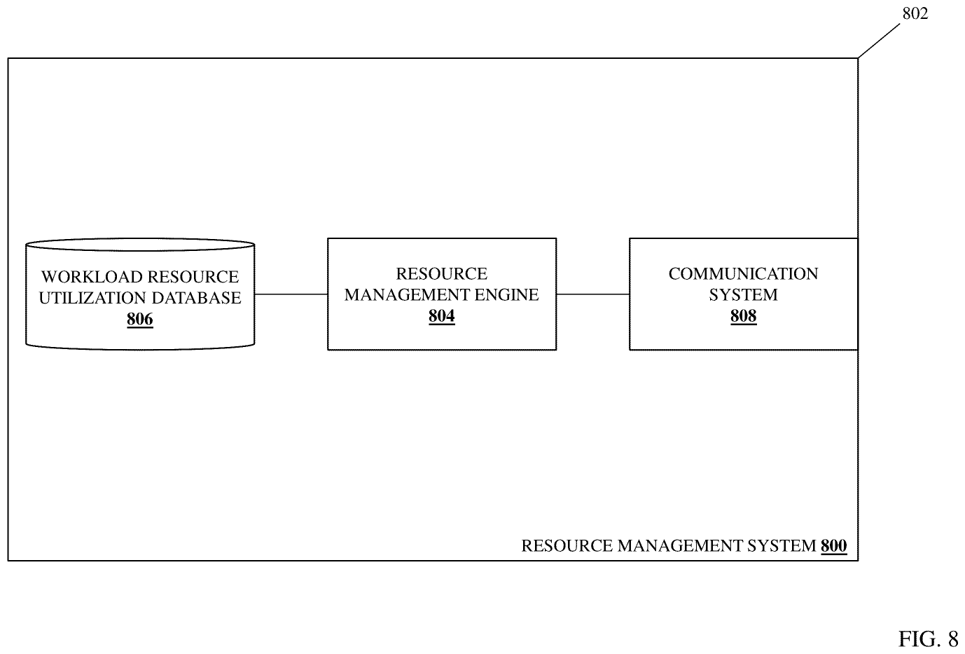

Referring now to FIG. 8, an embodiment of a resource management system 800 is illustrated that may provide the resource management system 702 discussed above with reference to FIG. 7. As such, the resource management system 800 may be provided by the IHS 100 discussed above with reference to FIG. 1 and/or may include some or all of the components of the IHS 100, and in specific examples may be provided by an SCPM. However, while illustrated and discussed as being provided by an SCPM, one of skill in the art in possession of the present disclosure will recognize that the functionality of the resource management system 800 discussed below may be provided by other devices that are configured to operate similarly as the resource management system 800 discussed below.

In the illustrated embodiment, the resource management system 800 includes a chassis 802 that houses the components of the resource management system 800, only some of which are illustrated and described below. For example, the chassis 802 may house a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide a resource management engine 804 that is configured to perform the functionality of the resource management engines and/or resource management systems discussed below.

The chassis 802 may also house a storage system (not illustrated, but which may include the storage 108 discussed above with reference to FIG. 1) that is coupled to the resource management engine 804 (e.g., via a coupling between the storage system and the processing system) and that includes a workload resource utilization database 806 that is configured to store any of the information utilized by the resource management engine 804 discussed below. The chassis 802 may also house a communication system 808 that is coupled to the resource management engine 804 (e.g., via a coupling between the communication system 808 and the processing system) and that may be provided by a Network Interface Controller (NIC), wireless communication systems (e.g., BLUETOOTH®, Near Field Communication (NFC) components, WiFi components, etc.), and/or any other communication components that would be apparent to one of skill in the art in possession of the present disclosure. However, while a specific resource management system 800 has been illustrated and described, one of skill in the art in possession of the present disclosure will recognize that resource management systems (or other devices operating according to the teachings of the present disclosure in a manner similar to that described below for the resource management system 800) may include a variety of components and/or component configurations for providing conventional resource management functionality, as well as the workload resource contention reduction functionality discussed below, while remaining within the scope of the present disclosure as well.

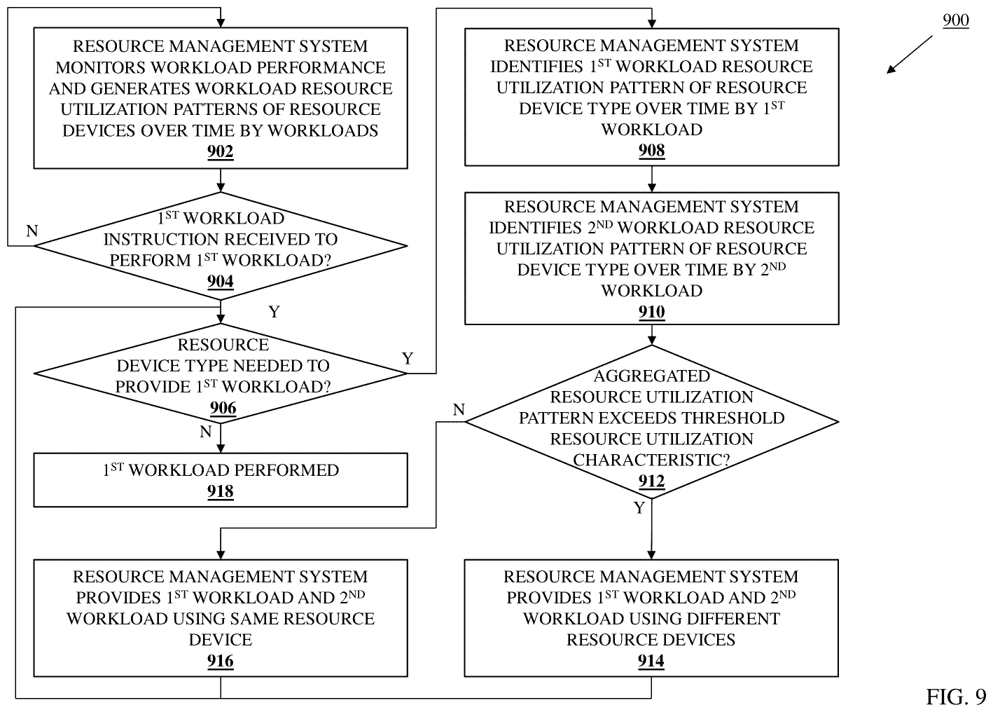

Referring now to FIG. 9, an embodiment of a method 900 for reducing resource contention from workloads is illustrated. As discussed below, the systems and methods of the present disclosure identify the resource utilization over time by workloads when considering a resource device for use in providing those workloads in order to identify when resource device contention may occur, and avoid using that resource device to provide each of those workloads if such resource contention is likely. For example, the workload/resource contention reduction system of the present disclosure may include a resource management system coupled to first and second resource devices. The resource management system receives a first workload instruction to perform a first workload, identifies a first workload resource utilization pattern of the first resource device over time by the first workload, and identifies a second workload resource utilization pattern of the first resource device over time by a second workload that is different than the first workload. The resource management system then determines whether an aggregated resource utilization pattern of the first workload resource utilization pattern and the second workload resource utilization pattern exceeds a threshold resource utilization characteristic. If not, the resource management system provides the first workload and the second workload using the first resource device. If so, the resource management system provides the first workload using the second resource device and the second workload using the first resource device. As such, multiple workloads may be provided using the same resource device in a manner that reduces workload contention by providing multiple workloads using the same resource device only when doing so avoids peak utilization of that resource device by each of those workloads, thus increasing the utilization of that resource device.

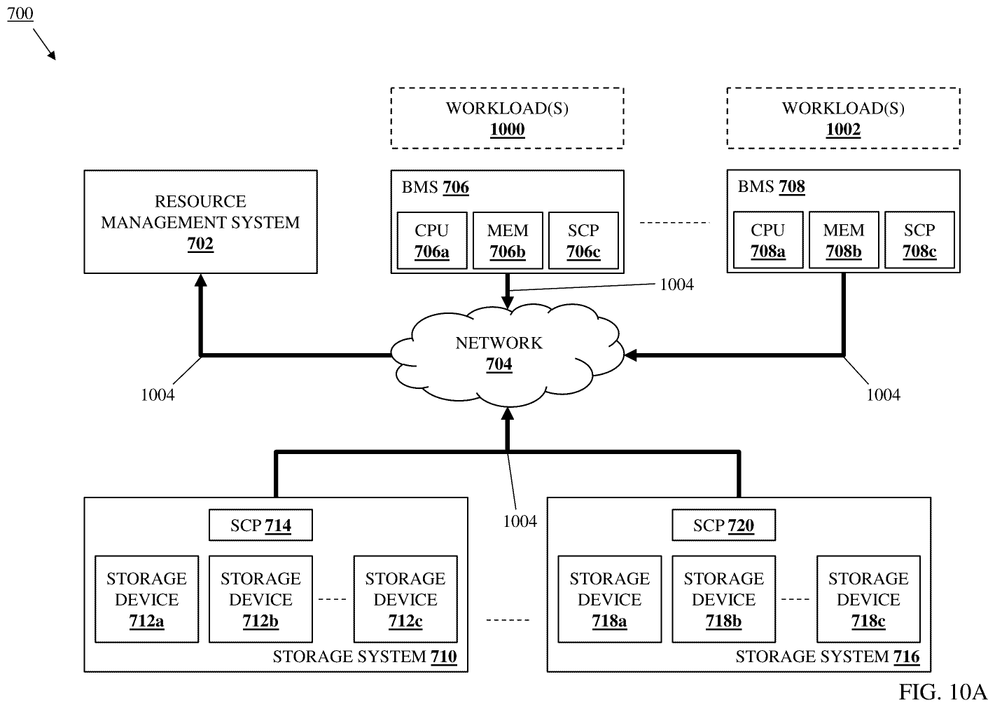

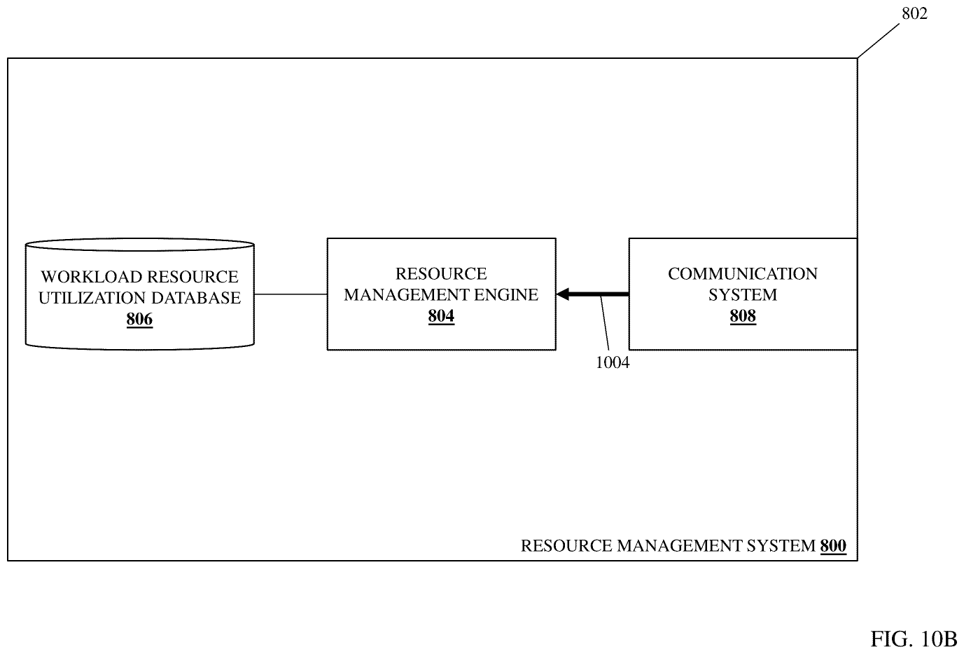

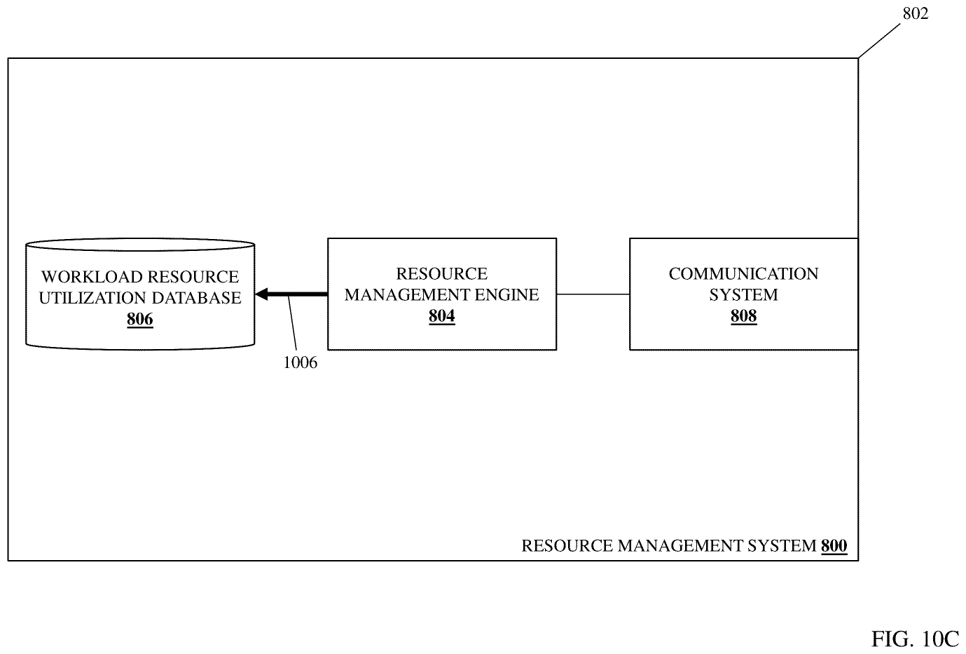

The method 900 begins at block 902 where a resource management system monitors workload performance and generates workload resource utilization patterns of resource devices over time by workloads. With reference to FIG. 10A, in an embodiment of block 902, the resource systems and/or resource devices in the LCS provisioning system 700 may perform workloads, with the specific example illustrated in FIG. 10A including one or more workloads 1000 being performed by the BMS 706, and one or more of workloads 1002 being performed by the BMS 708. As will be appreciated by one of skill in the art in possession of the present disclosure, any of the workload(s) 1000 may be provided by the CPU 706a and MEM 706b in the BMS 706 and any of the storage devices 712a-712c and 718a-718c in the storage systems 710 and 716, respectively, and may be performed using the SCP 706c in the BMS 706 and the SCPs 714 and/or 720 in the storage systems 710 and/or 716, respectively. Similarly, any of the workload(s) 1002 may be provided by the CPU 708a and MEM 708b in the BMS 708 and any of the storage devices 712a-712c and 718a-718c in the storage systems 710 and 716, respectively, and may be performed using the SCP 708c in the BMS 708 and the SCPs 714 and/or 720 in the storage systems 710 and/or 716, respectively.

With reference to FIGS. 10A and 10B, in an embodiment of block 902, the resource management system 702 may perform workload performance monitoring operations 1004 that, for any workload, including monitoring the resource devices that are being used to provide that workload via its communication system 808 and the network 704. For example, during the performance of each workload, telemetry data may be retrieved via the network 704 from the resource devices that are being used to provide that workload, and thus may include processing telemetry data from a processing device (e.g., the CPUS 706a or 708a) being used to provide that workload, memory telemetry data from a memory device (e.g., the MEM 706b or 708b) being used to provide that workload, networking telemetry data from a networking device (e.g., the SCP 706c or 708c) being used to provide that workload, storage telemetry data from a storage device (e.g., the storage devices 712a-712c and/or 718a-718c) being used to provide that workload, and/or any other telemetry data that would be apparent to one of skill in the art in possession of the present disclosure.

As such, the resource management system 702 may retrieve telemetry data from any of the resource devices being used to provide a workload from the beginning of the performance of that workload to the completion of the performance of that workload, with that telemetry data indicative of how that resource device was used over time to perform that workload, and one of skill in the art in possession of the present disclosure will appreciate how the resource management system 702 may perform time series analysis and/or other telemetry data analytic techniques in order to generate the workload resource utilization patterns described herein. For example, with reference to FIG. 10C and in an embodiment of block 902, the resource management engine 804 may perform workload resource utilization pattern generation operations 1006 that include generating workload resource utilization patterns of resource devices over time by workloads based on the monitoring of the performance of those workloads as described above, and storing those workload resource utilization patterns in its workload resource utilization database 806.

One of skill in the art in possession of the present disclosure will appreciate how the telemetry data retrieved via the monitoring of the performance of a workload using a resource device one or more times may be utilized to generate the workload resource utilization patterns that are illustrated and described below as having been stored in the workload resource utilization database 806. Furthermore, one of skill in the art in possession of the present disclosure will appreciate how the accuracy of any workload resource utilization pattern may be increased the more the performance of the corresponding workload using the corresponding resource device is monitored, with the workload resource utilization pattern generation operations 1006 including the updating of any workload resource utilization pattern that was previously generated and stored in the workload resource utilization database 806.

As such, for the performance of any given workload, workload resource utilization patterns may be generated and stored for each resource device used to perform that workload, and those workload resource utilization patterns may be refined after each performance of that workload using the same or similar resource devices. For example, a workload performed multiple times using the same processing system, memory system, networking system, and/or storage device may result in the refinement of workload resource utilization patterns stored in the workload resource utilization database 806 for those workload/resource device combinations. Furthermore, a workload performed multiple times using similar processing systems, memory systems, networking systems, and storage devices may result in the refinement of workload resource utilization patterns stored in the workload resource utilization database 806 for those workload/resource device combinations, with “similar” resource devices including resource device characteristics (e.g., resource device type, resource device speed, resource device features, etc.) that have a threshold similarity that may be defined in a variety of manners that would be apparent to one of skill in the art in possession of the present disclosure.

Thus, following block 902, multiple workload resource utilization patterns will be stored in the workload resource utilization database 806 for each workload that has been performed, with each workload resource utilization pattern describing how that workload uses a particular resource device during its performance. Furthermore, workload resource utilization patterns may be categorized by workload characteristics of the workload for which they were generated (e.g., workload types, workload categories, workload requirements, etc.), which as described below allows those workload resource utilization patterns to be used with new workloads whose performance has not been monitored before. However, while several specific examples of workload resource utilization patterns have been described, one of skill in the art in possession of the present disclosure will appreciate how the workload resource utilization patterns of the present disclosure may be provided in a variety of manners that will fall within the scope of the present disclosure as well.

The method 900 then proceeds to decision block 904 where the method 900 proceeds depending on whether a first workload instruction is received to perform a first workload. As described above, the resource management system 702/800 may receive a workload intent from any of the client devices 202 and, in response, may provide an LCS to perform a corresponding workload, and thus any of the workloads described below may be performed by any of the LCS discussed above. As such, in an embodiment of decision block 904, the resource management system 702/800 may monitor for workload instructions that provide those workload intents. If, at decision block 904, no first workload instruction to perform a first workload is received, the method 900 returns to block 902.

Thus, the method 900 may loop such that the resource management system continues to monitor workload performance and generate workload resource utilization patterns of resource devices over time by workloads until a workload instruction is received, and one of skill in the art in possession of the present disclosure will appreciate how the workload performance monitoring and workload resource utilization pattern generation may be continuously performed throughout the method 900 in response the performance of any workloads as described below.

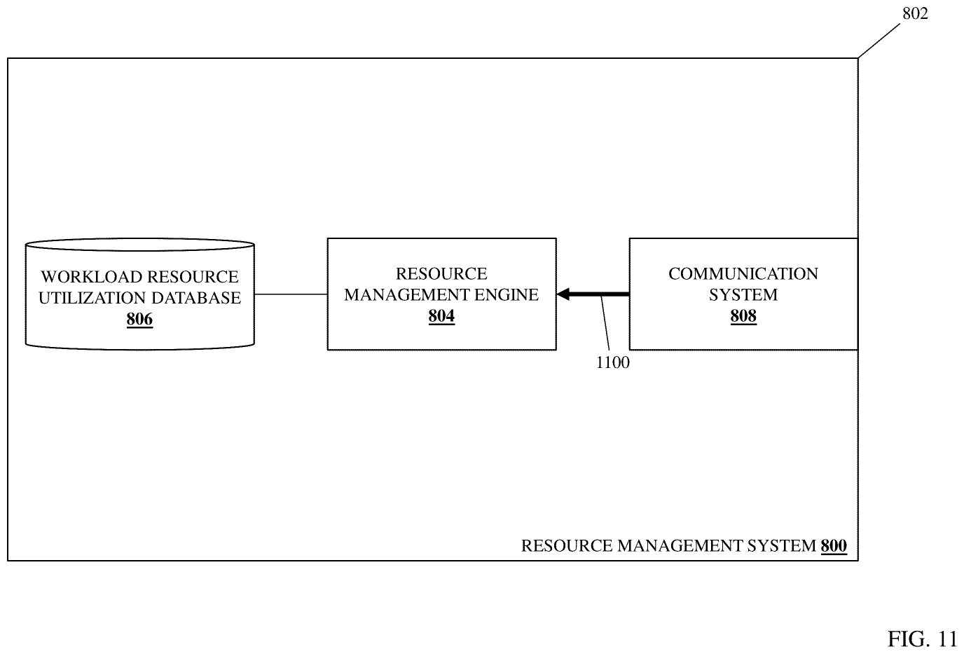

If, at decision block 904, a first workload instruction to perform a first workload is received, the method 900 proceeds to decision block 906 where the method 900 proceeds depending on whether a resource device type is needed to provide the first workload. With reference to FIG. 11, in an embodiment of decision block 904, the resource management engine 804 in the resource management device 702/800 may perform workload instruction receiving operations 1100 that include receiving a workload instruction to perform a workload (e.g., the workload intent described above) via its communication system 808. As discussed above, the workload that will be performed based on the workload instruction received at decision block 904 (e.g., by an LCS provided as described above) will require a plurality of resource devices of different resource device types such as, for example, the processing systems, memory systems, networking devices, and/or storage devices discussed above. As such, the method 900 may proceed at decision block 906 depending on whether any other resource device types are needed to provide the workload instructed at decision block 904.

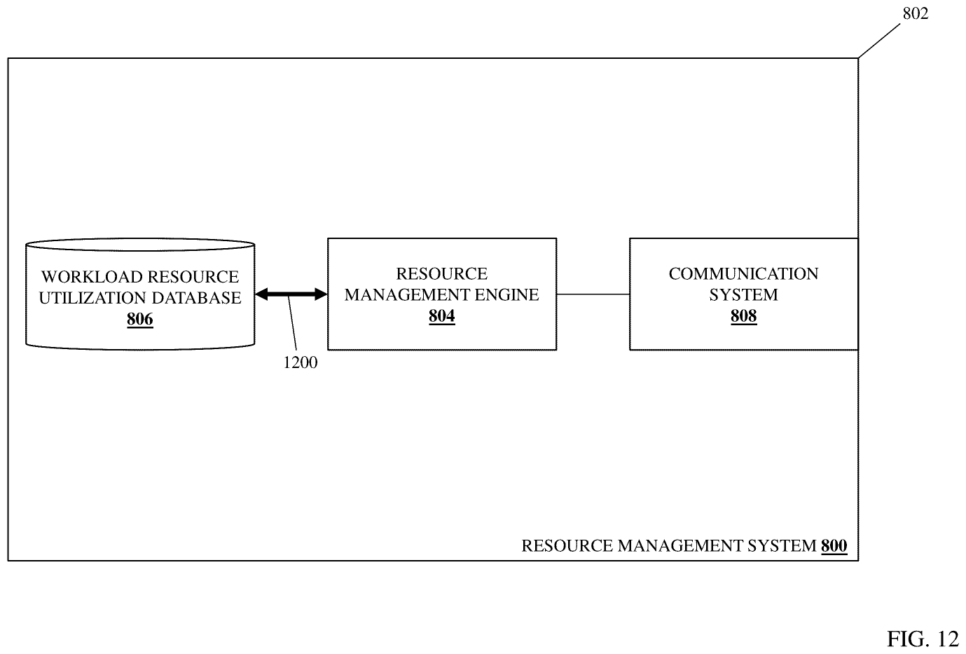

If, at decision block 906, a resource device type is needed to provide the first workload, the method 900 proceeds to block 908 where a resource management system identifies a first workload resource utilization pattern of the resource device type over time by the first workload. In this specific example of a first iteration of the method 900, a resource device type is needed at decision block 906 to provide the workload instructed at decision block 904. As such, with reference to FIG. 12 and in an embodiment of block 908, the resource management engine 804 in the resource management system 702/800 may perform workload resource utilization pattern identification operations 1200 that include identifying a workload resource utilization pattern in the workload resource utilization database 806 for the workload instructed at decision block 904 and the resource device type needed to provide that workload.

In an embodiment, the resource device type needed to provide the workload instructed at decision block 904 may be a particular processing system, a particular processing system type, a particular processing system capability, and/or other processing system functionality that would be apparent to one of skill in the art in possession of the present disclosure. To provide a specific example, at block 908 the resource management engine 804 may identify a workload resource utilization pattern that was previously generated (and in many cases, refined) for that workload using that processing system. In another specific example, at block 908 the resource management engine 804 may identify a workload resource utilization pattern that was previously generated (and in many cases, refined) for that workload using a similar processing system. In yet another specific example, at block 908 the resource management engine 804 may identify a workload resource utilization pattern that was previously generated (and in many cases, refined) for a similar workload (e.g., a workload having the same workload type, workload category, or workload requirements as the workload instructed at decision block 904) using that processing system. In yet another specific example, at block 908 the resource management engine 804 may identify a workload resource utilization pattern that was previously generated (and in many cases, refined) for a similar workload (e.g., a workload having the same workload type, workload category, or workload requirements as the workload instructed at decision block 904) using a similar processing system.

As such, for any workload instructed at decision block 904 and for a resource device that is needed to provide that workload, a corresponding workload resource utilization pattern may be identified that is indicative of how that workload will utilize that resource device over time based on, for example, previous performances of that workload using that resource device, previous performances of that workload using a similar resource device(s), previous performances of similar workloads using that resource device, and/or previous performances of similar workloads using similar resource devices, and one of skill in the art in possession of the present disclosure will appreciate how the workload resource utilization pattern for any workload/resource device combination will become more accurate as more workloads are performed using different resource devices.

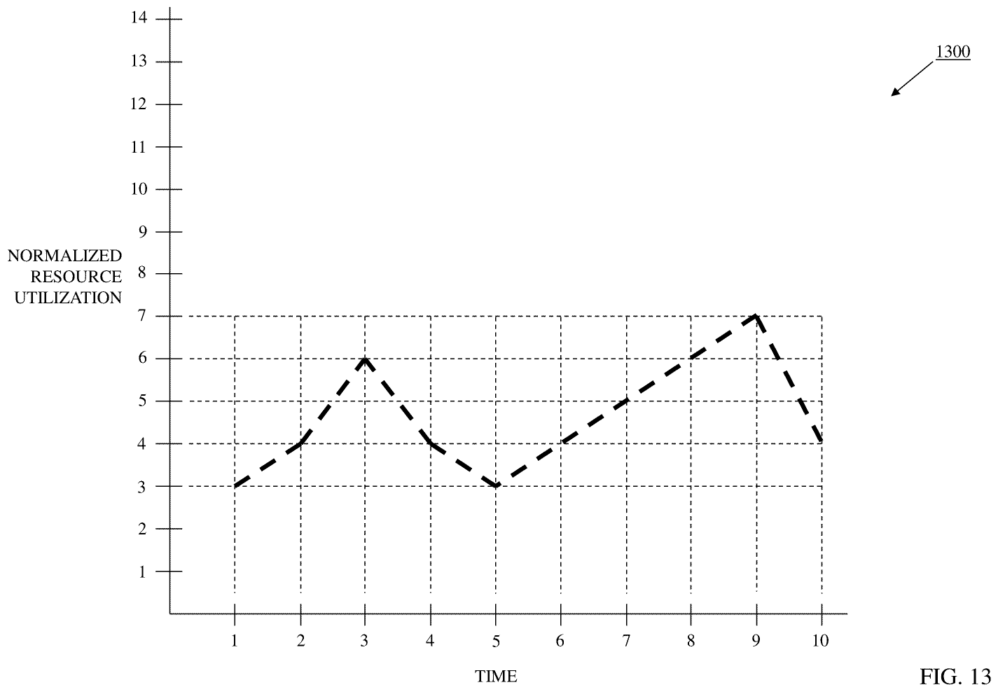

With reference to FIG. 13, an embodiment of a workload resource utilization pattern 1300 is illustrated that may be identified at block 908 for the workload instructed at decision block 904. In the example illustrated in FIG. 13, the workload resource utilization pattern 1300 plots a normalized resource utilization metric vs. time, and one of skill in the art in possession of the present disclosure will appreciate how any of a variety of resource utilization metrics may be normalized and plotted over any of a variety of time periods while remaining within the scope of the present disclosure. In the illustrated embodiment, the following data is used to provide the workload resource utilization pattern 1300:

| | NORMALIZED RESOURCE |
|---|---|
| TIME | UTILIZATION |
| 1 | 3 |
| 2 | 4 |
| 3 | 6 |
| 4 | 4 |
| 5 | 3 |
| 6 | 4 |
| 7 | 5 |
| 8 | 6 |
| 9 | 7 |
| 10 | 4 |
| AVERAGE | 4.6 |
| AVERAGE DEVIATION | 1.0182 |

Continuing with the specific example in which the resource device type is a processing system, the normalized resource utilization metric may be processing capacity of the processing system, and the time may be in hours. As such, the workload resource utilization pattern 1300 illustrates how the performance of the workload instructed at decision block 904 lasts 10 hours, with the processing system reaching a localized processing capacity peak of 6 at hour 3 (between a processing capacity of 3 at each of hour 1 and hour 5), and reaching another localized processing capacity peak of 7 at hour 9 (between a processing capacity of 3 at hour 5 and a processing capacity of 4 at hour 10).

In some examples, the time in the workload resource utilization pattern 1300 may be measured from a beginning of the performance of the workload to an end of the performance of the workload. As such, continuing with the example provided above, time 3 in the workload resource utilization pattern 1300 may be 3 hours after the workload was begun, time 6 may be 6 hours after the workload was begun, and so on. However, in other examples, the time in the workload resource utilization pattern 1300 may be measured as a time of day. As such, continuing with the example provided above, time 3 in the workload resource utilization pattern 1300 may be 3 pm, time 6 may be 6 pm, and so on. However, while specific time measurements are described, one of skill in the art in possession of the present disclosure will appreciate how a variety of time measurements will fall within the scope of the present disclosure as well.

The method 900 proceeds to block 910 where a resource management system identifies a second workload resource utilization pattern of the resource device type over time by a second workload. With reference back to FIG. 12, in an embodiment of block 910, the workload resource utilization pattern identification operations 1200 performed by the resource management engine 804 in the resource management system 702/800 may also include identifying a workload resource utilization pattern in the workload resource utilization database 806 for another workload that is being or may be provided by the resource device type that is needed to provide the workload that was instructed at decision block 904.

For example, in some embodiments, the resource device type needed to perform the workload instructed at decision block 904 (a “first workload”) may already be performing another workload (a “second workload”), and one of skill in the art in possession of the present disclosure will appreciate how the workload resource utilization pattern for that resource device type by the second workload may be identified to decide whether to use that resource device to provide the first workload in addition to providing the second workload. However, in another example, a “second” workload instruction for another workload (a “second workload”) may be received along with the workload instructed at decision block 904 (a “first workload”), and one of skill in the art in possession of the present disclosure will appreciate how the workload resource utilization pattern for the resource device type by the second workload may be identified to decide whether to provide both of the first workload and the second workload using that resource device. However, while specific examples of providing a “new” workload using a resource device that is already providing an “existing” workload, or providing multiple “new” ˜workloads using a resource device, have been described, one of skill in the art in possession of the present disclosure will appreciate how multiple workloads may be provided using a resource device in a variety of manners that will fall within the scope of the present disclosure as well.

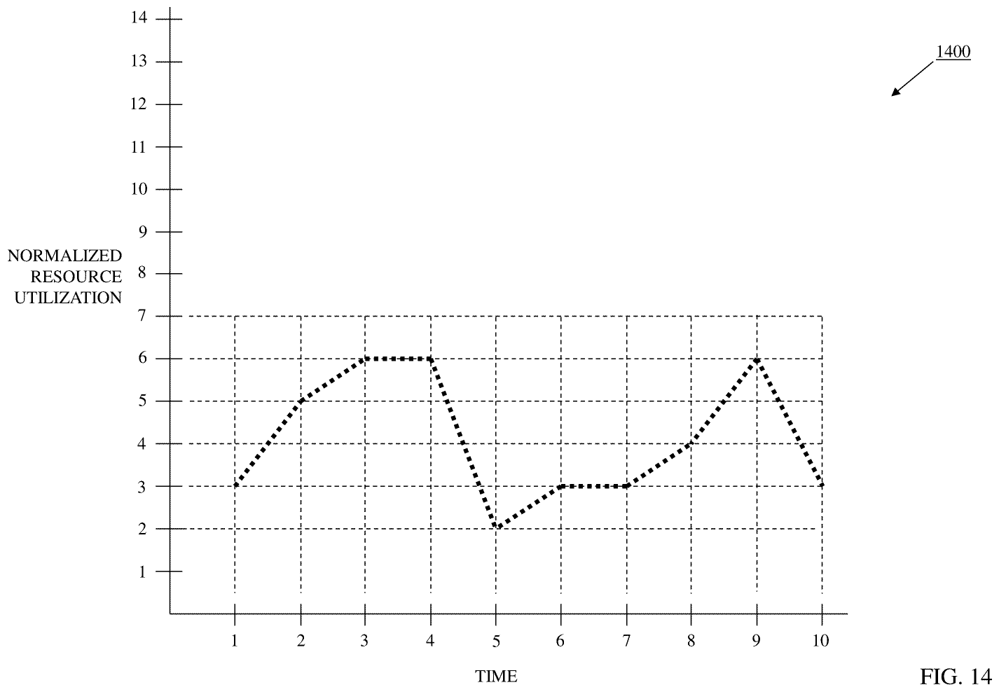

With reference to FIG. 14, an embodiment of a workload resource utilization pattern 1400 is illustrated that may be identified at block 910 for another workload that may share a resource device with the workload instructed at decision block 904. Similarly as described above, in the example illustrated in FIG. 14, the workload resource utilization pattern 1400 plots a normalized resource utilization metric vs. time, and one of skill in the art in possession of the present disclosure will appreciate how any of a variety of resource utilization metrics may be normalized and plotted over any of a variety of time periods while remaining within the scope of the present disclosure. In the illustrated embodiment, the following data is used to provide the workload resource utilization pattern 1400:

| | NORMALIZED RESOURCE |
|---|---|
| TIME | UTILIZATION |
| 1 | 3 |
| 2 | 5 |
| 3 | 6 |
| 4 | 6 |
| 5 | 2 |
| 6 | 3 |
| 7 | 3 |
| 8 | 4 |
| 9 | 6 |
| 10 | 3 |
| AVERAGE | 4.1 |
| AVERAGE DEVIATION | 1.2 |

Continuing with the specific example in which the resource device type is a processing system, the normalized resource utilization metric may be processing capacity of the processing system, and the time may be in hours. As such, the workload resource utilization pattern 1400 illustrates how the performance (or continued performance) of the other workload that may share a resource device with the workload instructed at decision block 904 lasts 10 hours, with the processing system reaching a localized processing capacity peak of 6 between hours 3 and 4 (between a processing capacity of 3 at hour 1 and a processing capacity of 2 at hour 5), and reaching another localized processing capacity peak of 9 at hour 9 (between a processing capacity of 2 at hour 5 and a processing capacity of 3 at hour 10).

Similarly as described above, in some examples, the time in the workload resource utilization pattern 1400 may be measured from a beginning of the performance of the workload to an end of the performance of the workload. As such, continuing with the example provided above, time 3 in the workload resource utilization pattern 1400 may be 3 hours after the workload was begun, time 6 may be 6 hours after the workload was begun, and so on. However, in other examples, the time in the workload resource utilization pattern 1400 may be measured as a time of day. As such, continuing with the example provided above, time 3 in the workload resource utilization pattern 1400 may be 3 pm, time 6 may be 6 pm, and so on. However, while specific time measurements are described, one of skill in the art in possession of the present disclosure will appreciate how a variety of time measurements will fall within the scope of the present disclosure as well.

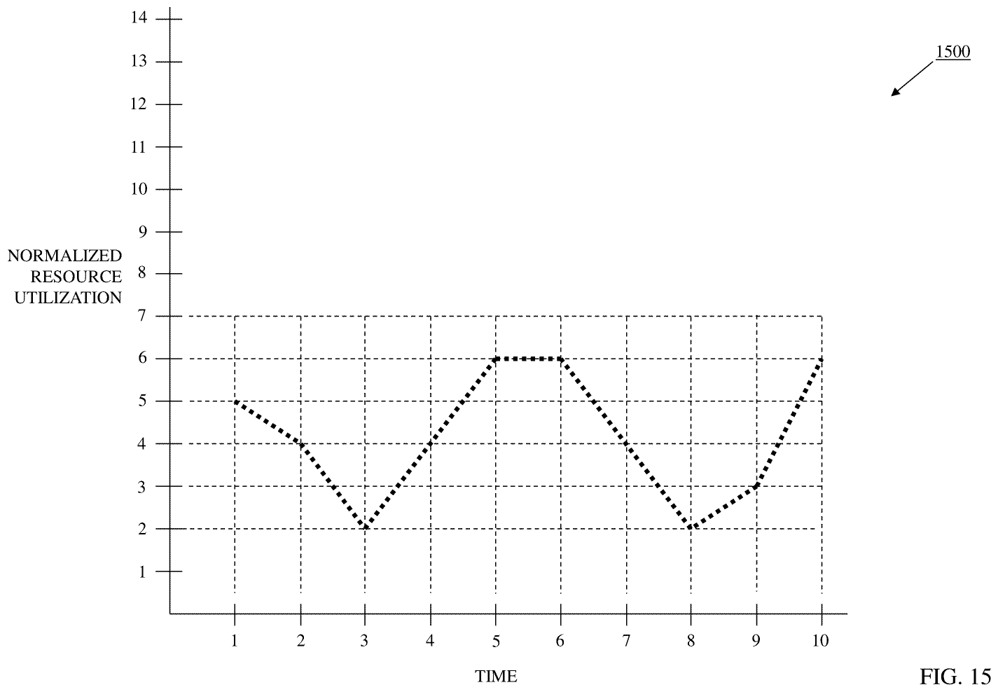

With reference to FIG. 15, an embodiment of a workload resource utilization pattern 1500 is illustrated that may be identified at block 910 for another workload that may share a resource device with the workload instructed at decision block 904. Similarly as described above, in the example illustrated in FIG. 15, the workload resource utilization pattern 1500 plots a normalized resource utilization metric vs. time, and one of skill in the art in possession of the present disclosure will appreciate how any of a variety of resource utilization metrics may be normalized and plotted over any of a variety of time periods while remaining within the scope of the present disclosure. In the illustrated embodiment, the following data is used to provide the workload resource utilization pattern 1500:

| | NORMALIZED RESOURCE |
|---|---|
| TIME | UTILIZATION |
| 1 | 5 |
| 2 | 4 |
| 3 | 2 |
| 4 | 4 |
| 5 | 6 |
| 6 | 6 |
| 7 | 4 |
| 8 | 2 |
| 9 | 3 |
| 10 | 10 |
| AVERAGE | 4.2 |
| AVERAGE DEVIATION | 1.127 |

Continuing with the specific example in which the resource device type is a processing system, the normalized resource utilization metric may be processing capacity of the processing system, and the time may be in hours. As such, the workload resource utilization pattern 1500 illustrates how the performance (or continued performance) of the other workload that may share a resource device with the workload instructed at decision block 904 lasts 10 hours, with the processing system reaching a localized processing capacity peak of 6 between hours 5 and 6 (between a processing capacity of 2 at hour 3 and a processing capacity of 2 at hour 8), and reaching another localized processing capacity peak of 6 at hour 10 (after a processing capacity of 2 at hour 8).

Similarly as described above, in some examples, the time in the workload resource utilization pattern 1500 may be measured from a beginning of the performance of the workload to an end of the performance of the workload. As such, continuing with the example provided above, time 3 in the workload resource utilization pattern 1400 may be 3 hours after the workload was begun, time 6 may be 6 hours after the workload was begun, and so on. However, in other examples, the time in the workload resource utilization pattern 1500 may be measured as a time of day. As such, continuing with the example provided above, time 3 in the workload resource utilization pattern 1500 may be 3 pm, time 6 may be 6 pm, and so on. However, while specific time measurements are described, one of skill in the art in possession of the present disclosure will appreciate how a variety of time measurements will fall within the scope of the present disclosure as well.

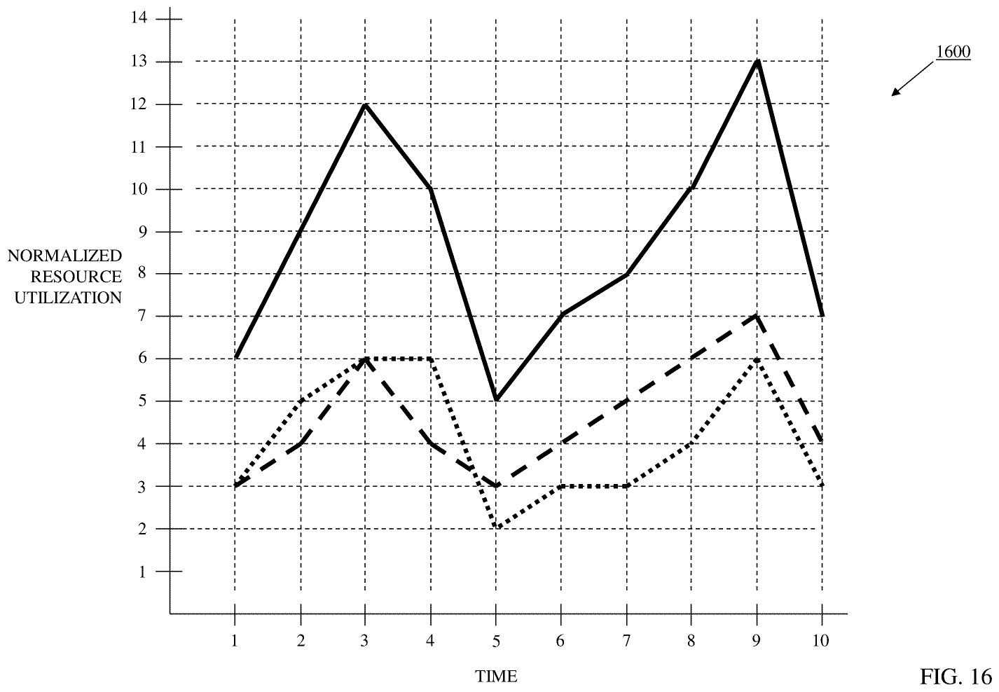

The method 900 then proceeds to decision block 912 where the resource management system determines whether an aggregated resource utilization pattern exceeds a threshold resource utilization characteristic. In an embodiment, at decision block 912, the resource management engine 804 in the resource management system 702/800 may perform aggregated resource utilization pattern generation operations that may include aggregating the workload resource utilization patterns identified at blocks 908 and 910. For example, FIG. 16 illustrates an embodiment of an aggregated resource utilization pattern 1600 that may be generated at decision block 912 using the workload resource utilization patterns 1300 and 1400, and that includes the following data:

| | WORKLOAD | WORKLOAD | AGGREGATED |
|---|---|---|---|
| | RESOURCE | RESORUCE | RESOURCE |
| | UTILIZATION | UTILIZATION | UTILIZATION |
| TIME | PATTERN 1300 | PATTERN 1400 | PATTERN 1600 |
| 1 | 3 | 3 | 6 |
| 2 | 4 | 5 | 9 |
| 3 | 6 | 6 | 12 |
| 4 | 4 | 6 | 10 |
| 5 | 3 | 2 | 5 |
| 6 | 4 | 3 | 7 |
| 7 | 5 | 3 | 8 |
| 8 | 6 | 4 | 10 |
| 9 | 7 | 6 | 13 |
| 10 | 4 | 3 | 7 |
| AVERAGE | 4.6 | 4.1 | 8.7 |
| AVERAGE | 1.0182 | 1.2 | 1.909 |
| DEVIATION | | | |

Continuing with the specific example in which the resource device type is a processing system, the normalized resource utilization metric may be processing capacity of the processing system, and the time may be in hours. As such, the aggregated resource utilization pattern 1600 illustrates how the performance of the workload instructed at decision block 904 using a resource device, along with the performance (or continued performance) of the other workload for which the workload resource utilization pattern 1400 was identified using that resource device as well, lasts 10 hours, with the processing system reaching a localized processing capacity peak of 12 at hour 3 (between a processing capacity of 6 at hour 1 and a processing capacity of 5 at hour 5), and reaching another localized processing capacity peak of 13 at hour 9 (between a processing capacity of 5 at hour 5 and a processing capacity of 7 at hour 10). However, while a specific example of an aggregated resource utilization pattern has been illustrated and described, one of skill in the art in possession of the present disclosure will appreciate how aggregated resource utilization patterns may be provided according to the teachings of the present disclosure in a variety of manners that will fall within the scope of the present disclosure as well.

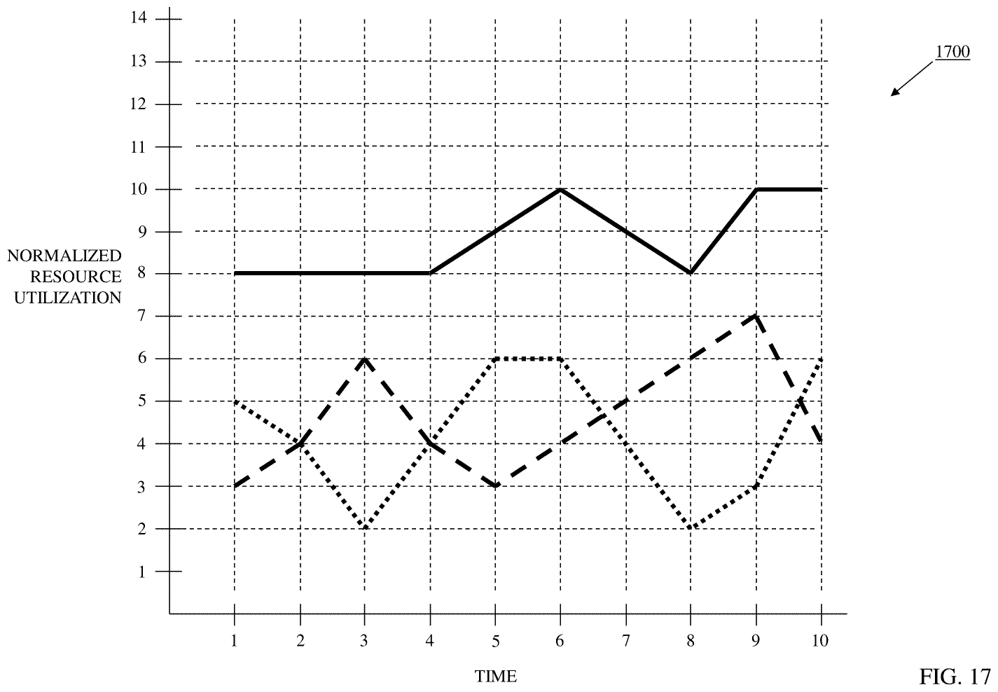

With reference to FIG. 17, in another embodiment of decision block 912, the aggregated resource utilization pattern generation operations performed by the resource management engine 804 in the resource management system 702/800 may generate an aggregated resource utilization pattern 1700 using the workload resource utilization patterns 1300 and 1500, and that includes the following data:

| | WORKLOAD | WORKLOAD | AGGREGATED |
|---|---|---|---|
| | RESOURCE | RESORUCE | RESOURCE |
| | UTILIZATION | UTILIZATION | UTILIZATION |
| TIME | PATTERN 1300 | PATTERN 1500 | PATTERN 1700 |
| 1 | 3 | 5 | 8 |
| 2 | 4 | 4 | 8 |
| 3 | 6 | 2 | 8 |
| 4 | 4 | 4 | 8 |
| 5 | 3 | 6 | 9 |
| 6 | 4 | 6 | 10 |
| 7 | 5 | 4 | 9 |
| 8 | 6 | 2 | 8 |
| 9 | 7 | 3 | 10 |
| 10 | 4 | 10 | 10 |
| AVERAGE | 4.6 | 4.2 | 8.8 |
| AVERAGE | 1.0182 | 1.127 | 0.727 |
| DEVIATION | | | |

Continuing with the specific example in which the resource device type is a processing system, the normalized resource utilization metric may be processing capacity of the processing system, and the time may be in hours. As such, the aggregated resource utilization pattern 1700 illustrates how the performance of the workload instructed at decision block 904 using a resource device, along with the performance (or continued performance) of the other workload for which the workload resource utilization pattern 1500 was identified using that resource device as well, lasts 10 hours, with the processing system reaching a localized processing capacity peak of 10 at hour 6 (between a processing capacity of 8 at hours 1-4 and a processing capacity of 8 at hour 8), and reaching another localized processing capacity peak of 10 at hours 9 and 10 (following a processing capacity of 8 at hour 8). However, while a specific example of an aggregated resource utilization pattern has been illustrated and described, one of skill in the art in possession of the present disclosure will appreciate how aggregated resource utilization patterns may be provided according to the teachings of the present disclosure in a variety of manners that will fall within the scope of the present disclosure as well.

In an embodiment, at decision block 912 and following the generation of the aggregated resource utilization pattern, the resource management engine 804 in the resource management system 702/800 may perform aggregated resource utilization pattern analysis operations that may include analyzing the aggregated resource utilization pattern to determine whether it exceeds a threshold resource utilization characteristic. As will be appreciated by one of skill in the art in possession of the present disclosure, the threshold resource utilization characteristic used at decision block 912 may be defined in a variety of manners for different resource devices based on a variety of criteria, and may be defined for any particular resource device to ensure that resource device meets minimum resource device performance characteristics and/or other resource device criteria that would be apparent to one of skill in the art in possession of the present disclosure.

In the particular examples provided below, the threshold resource utilization characteristic is a workload resource utilization pattern average deviation of the aggregated resource utilization pattern, as the inventors have found that workloads “work well together” with regard to any particular resource (i.e., those workloads share any particular resource device in a desirable manner) when the average deviation of their aggregated resource utilization pattern for that resource device is lower than the average deviation of any of their individual resource utilization patterns for that resource device. However, as described below, the threshold resource utilization characteristic of the present disclosure may be defined in any of a variety of other manners that will fall within the scope of the present disclosure as well.

If, at decision block 912, the resource management system determines that the aggregated resource utilization pattern exceeds the threshold resource utilization characteristic, the method 900 proceeds to block 914 where the resource management system provides the first workload and the second workload using different resource devices. Continuing with the examples provided above in which the resource device type is a processing system, the threshold resource utilization characteristic for the processing system may be a particular workload resource utilization pattern average deviation. In the specific examples provided below, the threshold resource utilization characteristic for the processing system is the lower of the workload resource utilization pattern average deviation for the workload resource utilization patterns that were identified for the workloads.

However, one of skill in the art in possession of the present disclosure will appreciate how the threshold resource utilization characteristic for the processing system may be the workload resource utilization pattern average deviation for any of the workload resource utilization patterns that were identified, a combination of (e.g., some mathematical result using the) workload resource utilization pattern average deviation for the workload resource utilization patterns that were identified, and/or other threshold resource utilization characteristics that one of skill in the art in possession of the present disclosure will appreciate may be based on the workload resource utilization pattern average deviations discussed above.

Furthermore, while specific examples of threshold resource utilization characteristics based on workload resource utilization pattern average deviations have been described, one of skill in the art in possession of the present disclosure will appreciate how any of a variety of other threshold resource utilization characteristics will fall within the scope of the present disclosure as well. For example, a maximum processing capability (e.g., a processing capability of 11 in the examples provided above) may be defined as the threshold resource utilization characteristic, and one of skill in the art in possession of the present disclosure will appreciate how in addition to resource device capabilities, resource device temperatures (e.g., temperature produced by the resource device in response to performing to the workload), acoustics (e.g., noise produced by the resource device in response to performing to the workload), and/or any other resource device utilization characteristics (or combinations thereof) may be used to define the threshold resource utilization characteristics of the present disclosure while remaining within the scope of the present disclosure as well.

As such, at decision block 912 and with reference to the aggregated resource utilization pattern 1600 provided in the specific example above, the resource management engine 804 in the resource management system 702/800 may determine that the threshold resource utilization characteristic has been exceeded based on the workload resource utilization pattern average deviation of the aggregated resource utilization pattern 1600 (i.e., “1.909”) exceeding the lower of the workload resource utilization pattern average deviation for the workload for which the workload resource utilization pattern 1300 was identified (i.e., “1.0182”) and the workload resource utilization pattern average deviation for the workload for which the workload resource utilization pattern 1400 was identified (i.e., “1.2”).

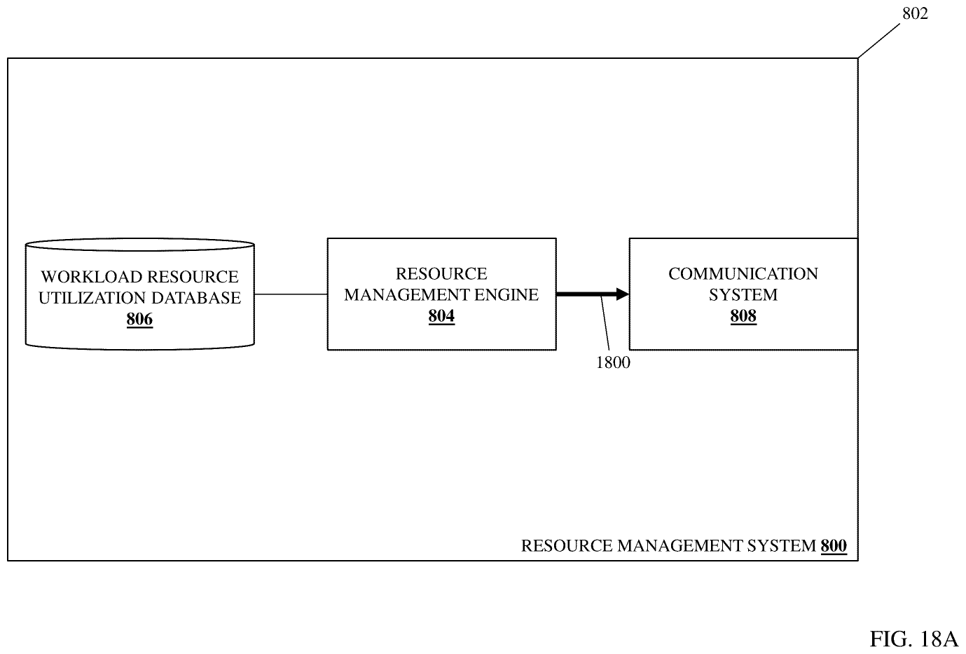

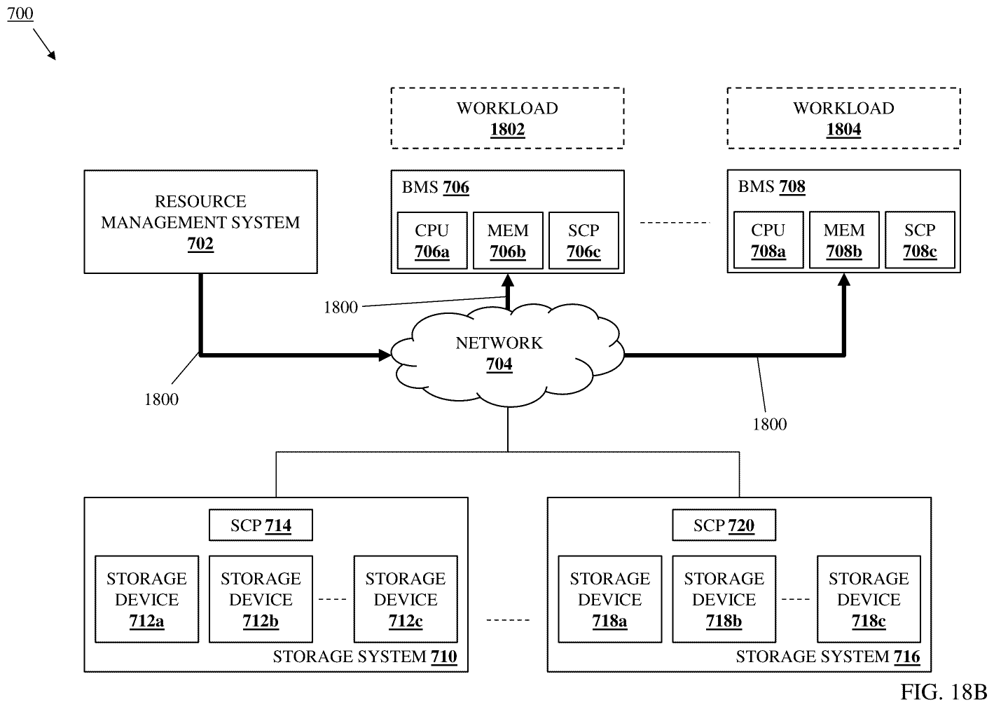

With reference to FIGS. 18A and 18B, in an embodiment of block 914 and in response to determining that the aggregated resource utilization pattern exceeds that threshold resource utilization characteristic, the resource management engine 804 in the resource management system 702/800 may perform, via its communicating system 808 and the network 704, workload provisioning operations 1800 that include “providing” a workload 1802 (which may be the workload that was instructed at decision block 904 and that is associated with the workload resource utilization pattern 1300 discussed above) using a resource device in the BMS 706, and “providing” a workload 1704 (which may be the workload that is associated with the workload resource utilization pattern 1400 discussed above) using a resource device in the BMS 708. As will be appreciated by one of skill in the art in possession of the present disclosure, the “providing” of the workloads 1802 and 1804 during this specific example of the first iteration of the method 900 may simply include reserving the processing system that provides the resource device in the BMS 706 for use in performing the workload 1802, and reserving the processing system that provides the resource device in the BMS 708 for use in performing the workload 1804, as the performance of those workloads 1802 and 1804 will begin once all of their needed resource device types have been reserved.

If, at decision block 912, the resource management system determines that the aggregated resource utilization pattern does not exceed the threshold resource utilization characteristic, the method 900 proceeds to block 916 where the resource management system provides the first workload and the second workload using the same resource device. In an embodiment, at decision block 912 and with reference to the aggregated resource utilization pattern 1700 provided in the specific example above, the resource management engine 804 in the resource management system 702/800 may determine that the threshold resource utilization characteristic has not been exceeded based on the workload resource utilization pattern average deviation of the aggregated resource utilization pattern 1700 (i.e., “0.727”) not exceeding the lower of the workload resource utilization pattern average deviation for the workload for which the workload resource utilization pattern 1300 was identified (i.e., “1.0182”) and the workload resource utilization pattern average deviation for the workload for which the workload resource utilization pattern 1500 was identified (i.e., “1.127”).

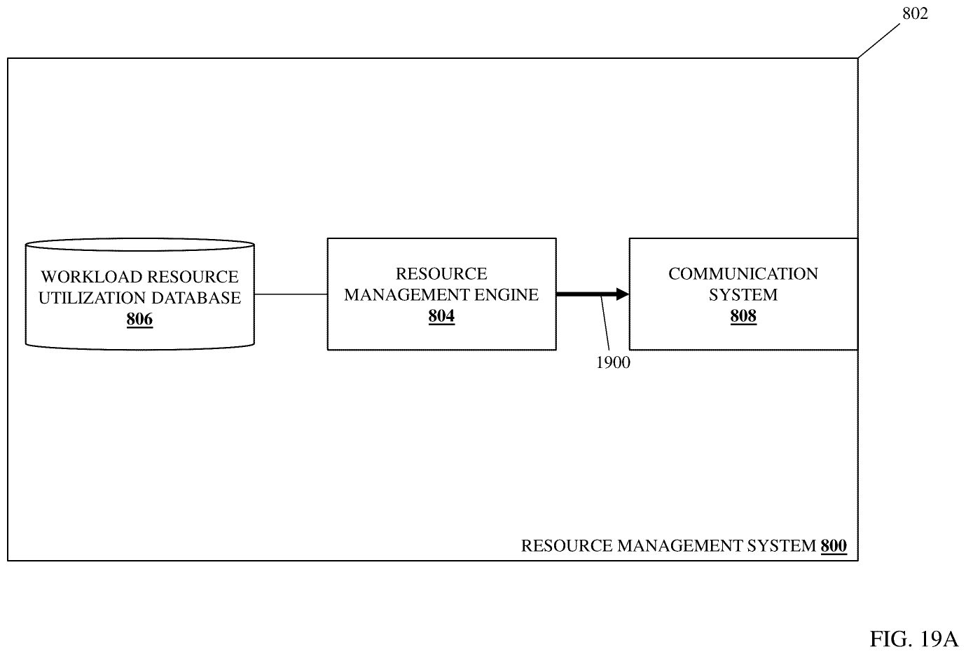

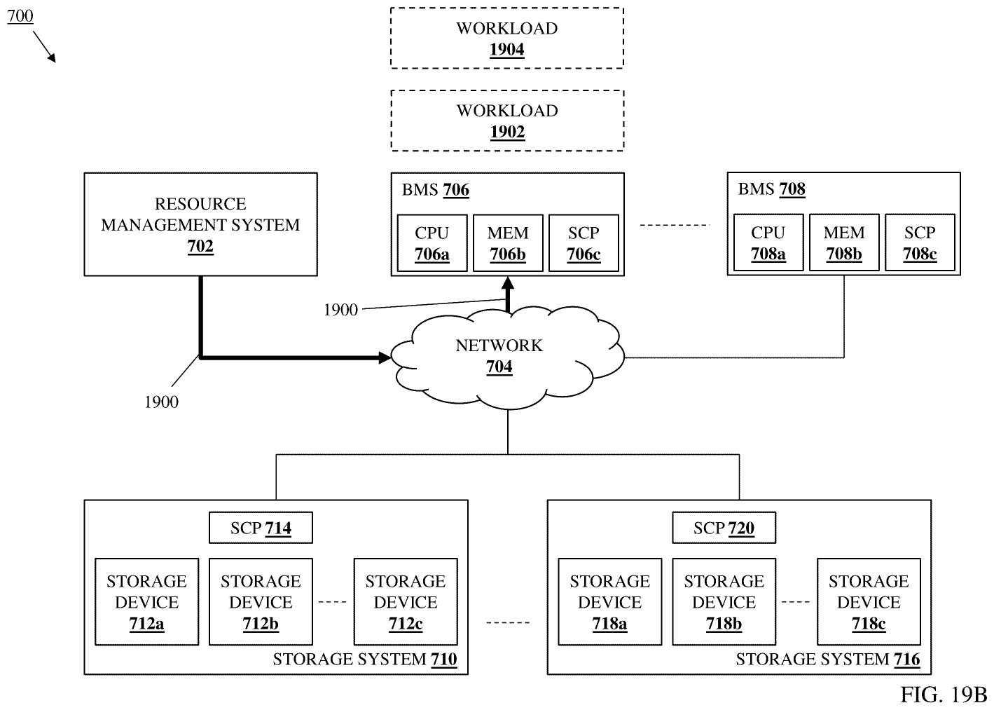

With reference to FIGS. 19A and 19B, in an embodiment of block 914 and in response to determining that the aggregated resource utilization pattern does not exceed the threshold resource utilization characteristic, the resource management engine 804 in the resource management system 702/800 may perform, via its communicating system 808 and the network 704, workload provisioning operations 1900 that include “providing” a workload 1902 (which may be the workload that was instructed at decision block 904 and that is associated with the workload resource utilization pattern 1300 discussed above) using a resource device in the BMS 706, and “providing” a workload 1904 (which may be the workload that is associated with the workload resource utilization pattern 1500 discussed above) using that resource device in the BMS 706. Similarly as described above, the “providing” of the workloads 1902 and 1904 during this specific example of the first iteration of the method 900 may simply include reserving the processing system that provides the resource device in the BMS 706 for use in performing the workload 1802 and the workload 1804, as the performance of those workloads 1802 and 1804 will begin once all of their needed resource device types have been reserved.

As discussed in some of the specific examples provided above, the workload resource utilization pattern of any workload described above measure resource device utilization by that workload from a beginning of the performance of that workload to an end of the performance of that workload, or may measure resource device utilization by that workload from a time of day. As such, in some embodiments, the timing of the performance of workloads may be shifted relative to each other in order to adjust the threshold resource utilization characteristic of their aggregated workload resource utilization pattern and allow them to be provided using the same resource device.

To provide some simplified examples, consider a pair of workloads having respective workload resource utilization patterns that each measure resource device utilization by that workload from a beginning of the performance of that workload to an end of the performance of that workload. If the performance of each of that pair of workloads must begin immediately, that will prevent the threshold resource utilization characteristic of their aggregated workload resource utilization pattern from being adjusted. However, if the performance of either or both of that pair of workloads may be delayed, that allows the shifting of their respective workload resource utilization patterns relative to each other to adjust the threshold resource utilization characteristic of their aggregated workload resource utilization pattern and possibly allow that pair of workloads to be provided using the same resource device.

To provide another simplified example, if a pair of workloads have respective workload resource utilization patterns that each measure resource device utilization by that workload from a time of day, that will prevent the threshold resource utilization characteristic of their aggregated workload resource utilization pattern from being adjusted. However, if a pair of workloads include a first workload having a workload resource utilization pattern that measures resource device utilization by that workload from a time of day, and a second workload having a workload resource utilization pattern that measures resource device utilization by that workload from a beginning of the performance of that workload to an end of the performance of that workload, and the performance of that second workload may be delayed, that allows the shifting of the workload resource utilization pattern for the second workload relative to the workload resource utilization pattern of the first workload in order to adjust the threshold resource utilization characteristic of their aggregated workload resource utilization pattern and possibly allow that pair of workloads to be provided using the same resource device.

Thus, one of skill in the art in possession of the present disclosure will appreciate how decision block 912 may include the resource management engine 804 in the resource management system 702/800 adjusting the relative timing of the performance of workloads that are being considering for provisioning by the same resource device in order to generate an aggregated resource utilization pattern that does not exceed the threshold resource utilization characteristic, and thus allow those workloads to be provided by the same resource device at block 916.

Following blocks 914 or 916, the method 900 returns to decision block 906. As such, the method 900 may loop such that, as long as an additional device type is required to provide the workload instructed at block 902, the resource management engine 804 in the resource management system 702/800 will identify a workload resource utilization pattern of a resource device of that resource device type over time by that workload, identify a workload resource utilization pattern of that resource device over time by other workload(s) (i.e., workloads currently being performed using that resource device, workloads being provided at the same time as the workload instructed at block 902, etc.), and then provide the workload instructed at block 902 based on whether an aggregated resource utilization pattern based on those identified workload resource utilization patterns exceeds a threshold resource utilization characteristic.

As such, one of skill in the art in possession of the present disclosure will appreciate how the workloads 1802 and 1902 (which were instructed at block 902 in the specific examples provided above) that were “provided” a processing system during the first iteration of the method 900 may be “provided” with memory systems, storage devices, networking devices, and/or any other resource devices during subsequent iterations of the method 900 substantially similarly as described above.

If, at decision block 906, no resource device type is needed to provide the first workload, the method 900 then proceeds to block 918 where the first workload is performed. In an embodiment, at block 918, and following the “provisioning” of the resource devices for the workload instructed at block 902 via one or more iterations of the method 900 (e.g., the reserving of those resource devices for use in providing that workload as described above), the workload instructed at block 902 may be performed similarly as described above. Furthermore, while not described herein in detail, one of skill in the art in possession of the present disclosure will appreciate how any workload performed at block 918 of the method 900 may be monitored at block 902 of the method 900 similarly as described above, and how the provisioning of that workload via any of its resource devices may be modified based on that monitoring (e.g., workloads provide using the same resource device may be monitored and, in the event their operation results in resource contention that was not predicted by their aggregated workload resource utilization pattern, they may be “rebalanced” or otherwise provided using different resource devices to alleviate that resource contention).

Thus, systems and methods have been described that identify the resource utilization over time by workloads when considering a resource device for use in providing those workloads in order to identify when resource device contention may occur, and avoid using that resource device for each of those workloads if such resource contention is likely. For example, the workload/resource contention reduction system of the present disclosure may include a resource management system coupled to first and second resource devices. The resource management system receives a first workload instruction to perform a first workload, identifies a first workload resource utilization pattern of the first resource device over time by the first workload, and identifies a second workload resource utilization pattern of the first resource device over time by a second workload that is different than the first workload. The resource management system then determines whether an aggregated resource utilization pattern of the first workload resource utilization pattern and the second workload resource utilization pattern exceeds a threshold resource utilization characteristic. If not, the resource management system provides the first workload and the second workload using the first resource device. If so, the resource management system provides the first workload using the second resource device and the second workload using the first resource device. As such, multiple workloads may be provided using the same resource device in a manner that reduces workload contention by providing multiple workloads using the same resource device only when doing so avoids peak utilization of that resource device by each of those workloads, thus increasing the utilization of that resource device.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A workload/resource contention reduction system, comprising:
a first resource device;
a second resource device; and
a resource management system that is coupled to the first resource device and the second resource device, wherein the resource management system is configured to:
receive a first workload instruction to perform a first workload;
identify a first workload resource utilization pattern of the first resource device over time by the first workload;
identify a second workload resource utilization pattern of the first resource device over time by a second workload that is different than the first workload;
determine whether an aggregated resource utilization pattern of the first workload resource utilization pattern and the second workload resource utilization pattern exceeds a threshold resource utilization characteristic;
provide, in response to the aggregated resource utilization pattern not exceeding the threshold resource utilization characteristic, the first workload and the second workload using the first resource device; and
provide, in response to the aggregated resource utilization pattern exceeding the threshold resource utilization characteristic, the first workload using the second resource device and the second workload using the first resource device.

2. The system of claim 1, wherein the second workload is provided using the first resource device prior to receiving the first workload instruction to perform the first workload.

3. The system of claim 1, wherein the resource management system is configured to:
receive a second workload instruction to perform the second workload, wherein the second workload is provided using the first resource device subsequent to receiving the first workload instruction to perform the first workload.

4. The system of claim 1, wherein the resource management system is configured to:
monitor, prior to receiving the first workload instruction, a plurality of performances of each of the first workload and the second workload;
generate, based on the monitoring of the plurality of performances of the first workload, the first workload resource utilization pattern of the first resource device over time by the first workload; and
generate, based on the monitoring of the plurality of performances of the second workload, the second workload resource utilization pattern of the first resource device over time by the second workload.

5. The system of claim 1, wherein the threshold resource utilization characteristic is one of:
a first workload resource utilization pattern average deviation of the first workload resource utilization pattern; and
a second workload resource utilization pattern average deviation of the second workload resource utilization pattern.

6. The system of claim 1, wherein the resource management system is configured to:
determine a workload category of the first workload; and
identify the first workload resource utilization pattern of the first resource device over time by the first workload based on the workload category of the first workload.

7. An Information Handling System (IHS), comprising:
a processing system; and
a memory system that is coupled to the processing system and that includes instructions that, when executed by the processing system, cause the processing system to provide a resource management engine that is configured to:
receive a first workload instruction to perform a first workload;
identify a first workload resource utilization pattern of a first resource device over time by the first workload;
identify a second workload resource utilization pattern of the first resource device over time by a second workload that is different than the first workload;
determine whether an aggregated resource utilization pattern of the first workload resource utilization pattern and the second workload resource utilization pattern exceeds a threshold resource utilization characteristic;
provide, in response to the aggregated resource utilization pattern not exceeding the threshold resource utilization characteristic, the first workload and the second workload using the first resource device; and
provide, in response to the aggregated resource utilization pattern exceeding the threshold resource utilization characteristic, the second workload using the first resource device and the first workload using a second resource device.

8. The IHS of claim 7, wherein the second workload is provided using the first resource device prior to receiving the first workload instruction to perform the first workload.

9. The IHS of claim 7, wherein the resource management engine is configured to:
receive a second workload instruction to perform the second workload, wherein the second workload is provided using the first resource device subsequent to receiving the first workload instruction to perform the first workload.

10. The IHS of claim 7, wherein the resource management engine is configured to:
monitor, prior to receiving the first workload instruction, a plurality of performances of each of the first workload and the second workload;
generate, based on the monitoring of the plurality of performances of the first workload, the first workload resource utilization pattern of the first resource device over time by the first workload; and
generate, based on the monitoring of the plurality of performances of the second workload, the second workload resource utilization pattern of the first resource device over time by the second workload.

11. The IHS of claim 7, wherein the threshold resource utilization characteristic is one of:
a first workload resource utilization pattern average deviation of the first workload resource utilization pattern; and
a second workload resource utilization pattern average deviation of the second workload resource utilization pattern.

12. The IHS of claim 7, wherein the resource management engine is configured to:
determine a workload category of the first workload; and
identify the first workload resource utilization pattern of the first resource device over time by the first workload based on the workload category of the first workload.

13. The IHS of claim 7, wherein the determining that the aggregated resource utilization pattern of the first workload resource utilization pattern and the second workload resource utilization pattern does not exceed the threshold resource utilization characteristic includes:
delaying a start time for the first workload relative to the provisioning of the second workload to cause the aggregated resource utilization pattern of the first workload resource utilization pattern and the second workload resource utilization pattern to not exceed the threshold resource utilization characteristic.

14. A method for reducing resource contention from workloads, comprising:
receiving, by a resource management system, a first workload instruction to perform a first workload;
identifying, by the resource management system, a first workload resource utilization pattern of a first resource device over time by the first workload;
identifying, by the resource management system, a second workload resource utilization pattern of the first resource device over time by a second workload that is different than the first workload;
determining, by the resource management system, whether an aggregated resource utilization pattern of the first workload resource utilization pattern and the second workload resource utilization pattern exceeds a threshold resource utilization characteristic;
providing, by the resource management system in response to the aggregated resource utilization pattern not exceeding the threshold resource utilization characteristic, the first workload and the second workload using the first resource device; and
providing, by the resource management system in response to the aggregated resource utilization pattern exceeding the threshold resource utilization characteristic, the second workload using the first resource device and the first workload using a second resource device.

15. The method of claim 14, wherein the second workload is provided using the first resource device prior to receiving the first workload instruction to perform the first workload.

16. The method of claim 14, further comprising:
receiving, by the resource management system, a second workload instruction to perform the second workload, wherein the second workload is provided using the first resource device subsequent to receiving the first workload instruction to perform the first workload.

17. The method of claim 14, further comprising:
monitoring, by the resource management system prior to receiving the first workload instruction, a plurality of performances of each of the first workload and the second workload;
generating, by the resource management system based on the monitoring of the plurality of performances of the first workload, the first workload resource utilization pattern of the first resource device over time by the first workload; and
generating, by the resource management system based on the monitoring of the plurality of performances of the second workload, the second workload resource utilization pattern of the first resource device over time by the second workload.

18. The method of claim 14, wherein the threshold resource utilization characteristic is one of:
a first workload resource utilization pattern average deviation of the first workload resource utilization pattern; and
a second workload resource utilization pattern average deviation of the second workload resource utilization pattern.

19. The method of claim 14, further comprising:
determining, by the resource management system, a workload category of the first workload; and
identifying, by the resource management system, the first workload resource utilization pattern of the first resource device over time by the first workload based on the workload category of the first workload.

20. The method of claim 14, wherein the determining that the aggregated resource utilization pattern of the first workload resource utilization pattern and the second workload resource utilization pattern does not exceed the threshold resource utilization characteristic includes:
delaying a start time for the first workload relative to the provisioning of the second workload to cause the aggregated resource utilization pattern of the first workload resource utilization pattern and the second workload resource utilization pattern to not exceed the threshold resource utilization characteristic.
